(19) United States
(12) Patent Application Publication
(10) Pub. No.: US 2009/0246576 A1
(43) Pub. Date: Oct. 1, 2009

(54) REACTION DEVICE AND ELECTRONIC EQUIPMENT

(75) Inventors: Tsutomu Terazaki, Tokyo (JP); Motoki Endo, Tokyo (JP); Tetsushi Ishikawa, Tokyo (JP); Osamu Nakamura, Tokyo (JP); Masaharu Shioya, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/410,626

(22) Filed: Mar. 25, 2009

(30) Foreign Application Priority Data
Mar. 27, 2008 (JP) 2008-083166
Mar. 27, 2008 (JP) 2008-083272
Mar. 27, 2008 (JP) 2008-083651

(51) Int. Cl. H01M 8/18; G21C 1/00

(52) U.S. Cl. 429/19; 422/159

(57) ABSTRACT

Disclosed is a reaction device including: a reaction device body including a reaction section in which a reactant reacts; and a first container to house the reaction device body, wherein the first container includes a radiation transmitting region through which radiation from the reaction device body transmits.

### CROSS-REFERENCE TO RELATED APPLICATIONS

This application is based upon and claims the benefit of priority under 35 USC 119 of Japanese Patent Application No. 2008-083166 filed on Mar. 27, 2008, Japanese Patent Application No. 2008-083272 filed on Mar. 27, 2008, and Japanese Patent Application No. 2008-083651 filed on Mar. 27, 2008, the entire disclosures of which, including the descriptions, claims, drawings, and abstract, are incorporated herein by reference in its entirety.

### BACKGROUND OF THE INVENTION

1. Field of the Invention

The present invention relates to a reaction device and electronic equipment which are used in a fuel cell device and the like.

2. Description of Related Art

A fuel cell is a device in which fuel and oxygen in the air react electrochemically so that an electric power is extracted directly from chemical energy.

In the case of using liquid fuel such as alcohols and gasoline as the fuel used in the fuel cell, it becomes necessary to provide a vaporizer to vaporize the liquid fuel; a reformer to allow the vaporized fuel to react with high temperature vapor so as to extract hydrogen necessary for electric power generation; a carbon monoxide remover to remove monoxide as a secondary product of the reform reaction, and so on.

Since operation temperatures of the vaporizer and the carbon monoxide remover are high, for example, Japanese Patent Application Laid-Open Publication No. 2004-303695 discloses housing these high temperature bodies as a reaction device body in high temperature body housing device as a heat insulating container to reduce heat loss.

In such heat insulating container, since a temperature of the reaction device body rises when a heat quantity transmitted from the reaction device body to the heat insulating container is suppressed, there is a possibility that appropriate temperature can not be maintained. On the other hand, in order to avoid such problem, for example, when the heat quantity transmitted from the reaction device body to the heat insulating container is increased, there is possibility that a temperature of external electronic equipment provided with the reaction device body rises.

### SUMMARY OF THE INVENTION

A reaction device according to the present invention includes: a reaction device body including a reaction section in which a reactant reacts; and a first container to house the reaction device body, wherein the first container includes a radiation transmitting region where the radiation from the reaction device body transmits.

Moreover, a reaction device according to the present invention includes: a fuel cell to produce an electric power by reaction of the reactant; a reaction device body includes an output electrode for sending the electric power of the fuel cell; and a first container to house the reaction device body, wherein the first container has the radiation transmitting region where the radiation from the reaction device body transmits, and an output electrode is placed opposite the radiation transmitting region in the first container.

Electronic equipment according to the present invention includes: the reaction device including a reaction device body containing a fuel cell to generate an electric power by reaction of the reactant and a first container to house the reaction device body, wherein the first container contains a radiation transmitting region where the radiation from the reaction device body transmits; and an electronic equipment body to operate by the electric power of the fuel cell.

Moreover, electronic equipment of the present invention includes: a reaction device including a reaction device body provided with a reaction section in which the reactant reacts and a connecting section through which a reactant to react in the reaction section or a product produced in the reaction section flows, and a first container to house the reaction device body, wherein the first container contains the radiation transmitting region where the radiation from the reaction device body transmits, and the connecting section is placed opposite the radiation transmitting region; and an electronic equipment to operate by the electric power of the fuel cell.

Furthermore, electronic equipment of the present invention includes: a reaction device including a fuel cell to produce an electric power by reaction of the reactant, a reaction device body provided with an output electrode for sending the electric power of the fuel cell, and a first container to house the reaction device body, wherein the first container includes a radiation transmitting region where the radiation from the reaction device body transmits, and the output electrode is placed opposite the radiation transmitting region in the first container; and an electronic equipment to operate by the electric power of the fuel cell.

### BRIEF DESCRIPTION OF THE DRAWINGS

The present invention will sufficiently be understood by the following detailed description and accompanying drawing, but they are provided for illustration only, and not for limiting the scope of the invention.

FIG. 1 is a schematic diagram showing a configuration of a reaction device 10A according to a first embodiment of the present invention;

FIG. 2 is a diagram showing a relation between radiation intensity and a wavelength within 100° C. to 1000° C.;

FIG. 3 is a graph showing a wavelength dependency of reflectance of Au, Al, Ag, Cu, Rh;

FIG. 4 is a graph showing a relation between a transmittance of substance which can be material of radiation transmitting windows 23, 25 and a wavelength of light;

FIG. 5 is a graph showing a relation between the transmittance of substance which can be material of the radiation transmitting windows 23, 25 and the wavelength of light;

FIG. 6 is a schematic diagram showing a configuration of a reaction device 10B according to a first variation of the present invention;

FIG. 7 is a view on arrow VII of FIG. 6;

FIG. 8 is a schematic diagram showing a configuration of a reaction device 10C according to a second variation of the present invention;

FIG. 9 is a schematic diagram showing a configuration of a reaction device 10D according to a third variation of the present invention;

FIG. 10 is a block diagram showing electronic equipment 100 according to a second embodiment of the present invention;

FIG. 11 is a perspective diagram of a reaction device 110;

FIG. 12 is a schematic cross-section diagram corresponding to a cutting-plane line XII-XII in FIG. 11;

FIG. 13 is a view on arrow XIII of FIG. 11;

FIG. 14 is a block diagram showing electronic equipment 200 according to a third embodiment of the present invention;

FIG. 15 is a perspective diagram of a reaction device 210;

FIG. 16 is a schematic cross-section diagram corresponding to a cutting-plane line XVI-XVI in FIG. 15;

FIG. 17 is a view on arrow XVII of FIG. 15;

FIG. 18 is a block diagram showing electronic equipment 300 according to a fourth embodiment of the present invention;

FIG. 19 is a perspective diagram of a reaction device 310;

FIG. 20 is a schematic cross-section diagram corresponding to a cutting-plane line XX-XX in FIG. 19;

FIG. 21 is a view on arrow XVII of FIG. 19;

FIG. 22 is a schematic cross-section diagram showing a configuration of a reaction device 310A according to a fourth variation of the present invention;

FIG. 23 is a schematic cross-section diagram showing a configuration of a reaction device 310B according to a fifth variation of the present invention;

FIG. 24 is a perspective diagram showing a configuration example of the electronic equipment 300 according the fourth embodiment of the present invention;

FIG. 25 is a schematic cross-section diagram of the reaction device 310C according to a fifth embodiment of the present invention similar to FIG. 20;

FIG. 26 is a view on arrow XXVI of FIG. 25 similar to FIG. 21;

FIG. 27 is a bottom diagram of a reaction device 310D according to a first example of the present invention;

FIG. 28 is a bottom diagram of a reaction device 310E according to a second example of the present invention;

FIG. 29 is a graph showing a result of calculating a relation between a length of a third connecting section 316 from a high temperature reaction section 317 and a temperature;

FIG. 30 is a schematic cross-section diagram showing a configuration of a reaction device 310F according to a sixth variation of the present invention;

FIG. 31 is a schematic cross-section diagram showing a configuration of a reaction device 310G according to a seventh variation of the present invention;

FIG. 32 is a schematic cross-section diagram showing a reaction device 310H according to a sixth embodiment of the present invention;

FIG. 33 is a view on arrow XXXIII of FIG. 32 similar to FIG. 21;

FIG. 34 is a bottom diagram of a reaction device 310I according to a third example of the present invention;

FIG. 35 is a bottom diagram of a reaction device 310J according to a fifth example of the present invention;

FIG. 36 is a graph showing a result of calculating a relation between lengths of an anode output electrode 346 and a cathode output electrode 347 from the high temperature reaction section 317 and a temperature;

FIG. 37 is a schematic diagram showing a temperature and heat quantity of a reaction device 310K according to a fifth comparative example of the present invention in a steady state;

FIG. 38 is a schematic diagram for explaining an ideal heat exchange; and

FIG. 39 is a schematic diagram showing a temperature and heat quantity of a reaction device 310L according to a seventh embodiment of the present invention in a steady state.

### DETAILED DESCRIPTION OF THE PREFERRED EMBODIMENTS

In the following, the best modes for implementing the present invention will be described with reference to the drawings. Although technically preferable various limitations for implementing the present invention are given to the embodiments described below, the limitations are not intended to limit the scope of the present invention to the following embodiments and shown examples.

### First Embodiment

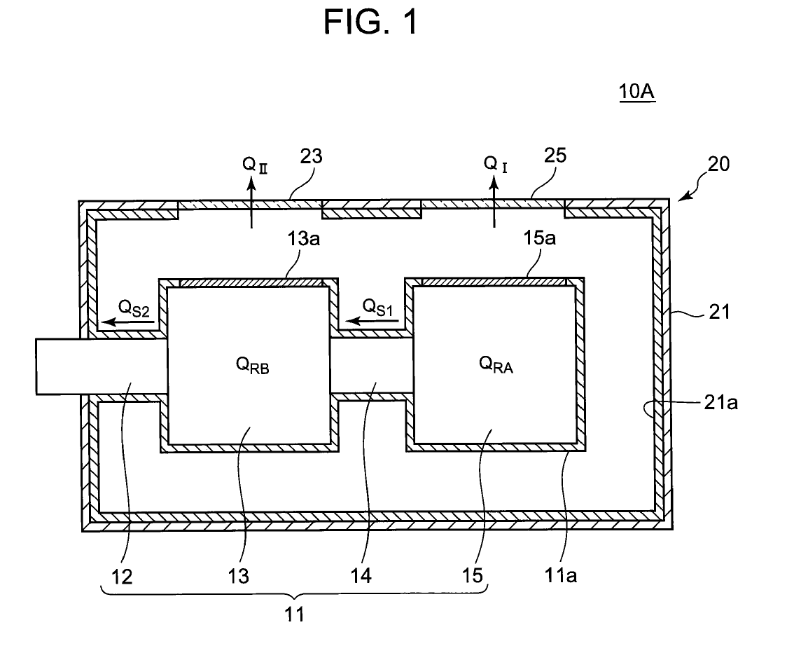

FIG. 1 is a schematic diagram showing a configuration of a reaction device 10A according to the first embodiment of the present invention. As shown in FIG. 1, the reaction device 10A is composed of a reaction device body 11 and a heat insulating container (first container) 20 to house the reaction device body 11. The reaction device 10A may be formed by bonding metal plates such as stainless (SUS304), kovar alloy and nickel base alloy, for example, or bonding optical materials or glass substrates.

A radiation preventing film 11a for preventing a radiation is formed on an external wall surface of the reaction device body 11 except portions where radiation discharging films 13a, 15a are formed. As material of the radiation preventing film 11a, same material as that of a reflective film 21a referred to hereinafter may be used. The radiation preventing film 11a prevents a movement of heat quantity to outside of the reaction device 10A due to a radiation from the reaction device 10A.

The reaction device body 11 includes: a first connecting section 12; a low temperature reaction section 13; a second connecting section 14; and a high temperature reaction section 15. The high temperature reaction section 15 is kept at higher temperature than the low temperature section 13.

As shown in FIG. 1, the radiation discharging films 13a, 15a are formed respectively on outer surfaces of the low temperature section 13 and the high temperature section 15. As the radiation discharging films 13a, 15a, materials having high emissivity which is 0.5 or more, more preferably 0.8 or more, in an infrared range of 1-30 μm may be used.

The radiation discharging films 13a, 15a may be laminated on the radiation preventing film 11a after the radiation preventing film 11a is formed on whole surface of the reaction device body 11.

As materials of the radiation discharging films 13a, 15a, materials capable of being produced easily may be selected, and various oxides as represented by SiO₂ or alumina (Al₂O₃), clay mineral such as kaolin, ceramic and the like may be used. For example, SiO₂, Al₂O₃, kaolin, RFeO₃ (R is rare earthes), hafnium oxide, YSZ, heat-resistant radiation coating material including titanium oxide, and so on may be used.

The radiation discharging films 13a, 15a may be formed in a sheet-like shape, for example, by applying emulsion liquid including material of high emissivity to a substrate and the like and drying the emulsion liquid.

Alternatively, the radiation discharging films 13a, 15a may be formed by a non-evaporation type getter which absorbs gas inside the insulating container 20.

On the other hand, materials having an electric conductivity, for example normal metal and graphite which looks black in a visible light region can not be used as the material of the radiation discharging films 13a, 15a because their emissivity becomes low in a long wavelength region including an infrared region.

Moreover, the radiation discharging films 13a, 15a may be formed by forming Al₂O₃ in a porous body shape on an outer surface of a chassis 21 in a method such as an anodic oxidation. Alternatively, a cloth using thin glass fiber may be used as the radiation discharging films 13a, 15a.

The radiation discharging films 13a, 15a are placed opposite radiation transmitting windows 23, 25 in an inner wall surface of the heat insulating container 20.

The first connecting section 12 includes a pipe as a flow path through which a reactant to react at the high temperature reaction section 15 or the low temperature reaction section 13 and a product to be produced flow. The first connecting section 12 is connected to the low temperature reaction section 13 at one end, penetrates through the insulating container 20 on the other end side, and is connected to a not-shown external apparatus at the other end. The first connecting section 12 includes a first pipe (outflow pipe) as a flow path for sending the reactant and the product from the low temperature reaction section 13 to outside of the heat insulating container 20, and a second pipe (inflow pipe) for sending the reactant and the product from outside of the heat insulating container 20 to the low temperature reaction section 13.

The second connecting section 14 includes a pipe as a flow path through which a reactant to react at the high temperature reaction section 15 or the low temperature reaction section 13 and a product to be produced flow, and connects the high temperature reaction section 15 and the low temperature reaction section 13. The second connecting section 14 is connected to the high temperature reaction section 15 at one end, and connected to the low temperature reaction section 13 at the other end. The second connecting section 14 includes a third pipe (outflow pipe) as a flow path for sending the reactant and the product from the high temperature reaction section 15 to the low temperature reaction section 13, and a fourth pipe (inflow pipe) for sending the reactant and the product from the low temperature reaction section 13 to the high temperature reaction section 15.

Next, the heat insulating container 20 will be explained. The heat insulating container 20 has a rectangular solid shape, and houses the reaction device body 11 inside.

An inner space of the heat insulating container 20 is maintained at lower pressure than an atmospheric pressure, for example, 10 Pa or less, more preferably 1 Pa or less, in order to prevent heat conduction or convection flow by gas molecule.

The heat insulating container 20 is roughly composed of a chassis 21, the radiation transmitting windows 23, 25, and the reflective film 21a.

On the inner wall surface of the chassis 21, the reflective film 21a is formed to reflect the radiation in order to suppress a heat loss due to the radiation from the reaction device body 11. Material of the reflective film 21a will be described later. The reflective film 21a suppresses a movement of the heat quantity to the chassis 21 due to the radiation from the reaction device body 11.

Because the heat quantity is conducted from the high temperature reaction section 15 to the low temperature reaction section 13 through the second connecting section 14, if the conducted heat quantity is equal to heal quantity conducted to the heat insulating container 20 through the first connecting section 12 or more, there is a possibility that the temperature rises to more than a proper temperature. For this reason, the radiation transmitting windows 23, 25 are respectively provided in positions corresponding to the low temperature reaction section 13 and the high temperature reaction section 15 in the inner wall surface of the heat insulating container 20 according to the embodiment.

The radiation transmitting windows 23, 25 have higher radiation transmission in the infrared region in comparison with a region where the reflective film 21a is formed on the inner wall surface of the heat insulating container 20. The radiation transmitting window 25 allows the radiation from the radiation discharging film 15a of the high temperature reaction section 15 to transmit to be discharged outside of the heat insulating container 20.

The radiation transmitting windows 23, 25 are placed, for example, as shown in FIG. 1, in positions facing the radiation discharging films 13a, 15a, and are formed of materials having high radiation transmission in the infrared region. The materials of the radiation transmitting windows 23, 25 will be described later.

The heat movement in the reaction device 10A will be explained.

Generally, when it is supposed that heat transmission quantity of solid is Q, heat conductivity is k, a cross-section area is S, a temperature difference is ΔT, and a heat transfer length is Δx, the following formula (1) is satisfied.

### [Formula 1]

Q=−kSΔT/Δx (1)

Therefore, heat transmission quantity Q_{S1} from the high temperature reaction section 15 to the low temperature reaction section 13 through the second connecting section 14 is proportional to a temperature difference between the high temperature reaction section 15 and the low temperature reaction section 13, and heat conductivity and a cross-section area of the second connecting section 14, and inversely proportional to a length of the second connecting section 14. Similarly, heat transmission quantity Q_{S2} from the low temperature reaction section 13 to the heat insulating container 20 is proportional to a temperature difference between the low temperature reaction section 13 and the heat insulating container 20, heat conductivity and a cross-section area of the first connecting section 12, and inversely proportional to a length of the first connecting section 12 from the low temperature reaction section 13 to the heat insulating container 20.

Next, heat discharge amount by the radiation discharging films 13a, 15a will be considered.

When it is supposed that a heat budget by heat transfer between reaction heat inside the high temperature reaction section 15 and flowing gas is Q_{RA}, a heat budget inside the low temperature reaction section 13 is Q_{RB}, heat discharge amount by the radiation discharging film 15a is Q_{I}, and heat discharge amount by the radiation discharging film 13a is Q_{II}, the following formulas (2), (3) are satisfied in a condition of thermal equilibrium.

### [Formula 2]

Q_{RA}−Q_{I}−Q_{S1}=0 (2)

Q_{RB}−Q_{II}+Q_{S1}−Q_{S2} =0 (3)

According to the formulas (2), (3), a total heat budgets of the low temperature reaction section 13 and the high temperature reaction section 15 is a sum of Q_{I}, Q_{II}, and Q_{S2}. Therefore, it is necessary to set the heat discharge amount properly depending on the heat budget of each of the reaction sections 13, 15 in order to maintain the temperature of each of the reaction sections properly. Since the heat transmission quantity Q_{S2} to the heat insulating container becomes equal to heat transmission quantity to the external apparatus through the heat insulating container, it is necessary to suppress Q_{S2} in order to prevent a temperature of the external apparatus from rising. On the other hand, since the heat discharge amounts Q_{I}, Q_{II} by the radiation discharging films 15a, 13a are discharged to the exterior through the radiation transmitting windows 23, 25, by placing each of the radiation transmitting windows properly, it becomes possible to prevent the heat from transmitting to the external apparatus. Therefore, by setting the heat discharge amounts Q_{I}, Q_{II} depending on the total heat budget in the reaction sections 13, 15 and the suppressed heat transmission quantity Q_{S2} to the heat insulating container, it is possible to suppress the heat transmission quantity Q_{S2} to the external apparatus while maintaining the temperature of each of the reaction sections 13, 15 in a proper temperature.

According to Stefan-Boltzmann law, a total radiation energy amount E (W/m²) discharged per unit of time from an object having an absolute temperature T (K), an emissivity ε, a surface area A (m²) is represented by the following formula (4).

### [Formula 3]

E=εσAT⁴ (4)

Incidentally, δ is Stefan-Boltzmann's constant, and δ=5.67×10⁻⁸ (W/m²/K⁴). Therefore, the heat discharge amounts Q_{I}, Q_{II} can be adjusted by changing areas of the radiation discharging films 13a, 15a or selecting material of an appropriate emissivity.

Next, a wavelength of the radiation emitted from the radiation discharging films 13a, 15a and materials of the radiation transmitting windows 23, 25 will be considered.

A blackbody radiation intensity B (λ) of an electromagnetic wave of wavelength λ discharged from a blackbody of the temperature T (K) is provided by the following formula (5) referred to as Planck's formula.

### [Formula 4]

B(λ)=(2πhc²/λ⁵)/(exp(hc/λkT)−1) (5)

According to Wien's displacement law, a wavelength λₘₐₓ (m) at which the radiation intensity from the blackbody of the temperature T (K) achieves a peak is inversely proportional to the temperature T (K), and represented by the following formula (6).

### [Formula 5]

λₘₐₓ=0.002898/T (6)

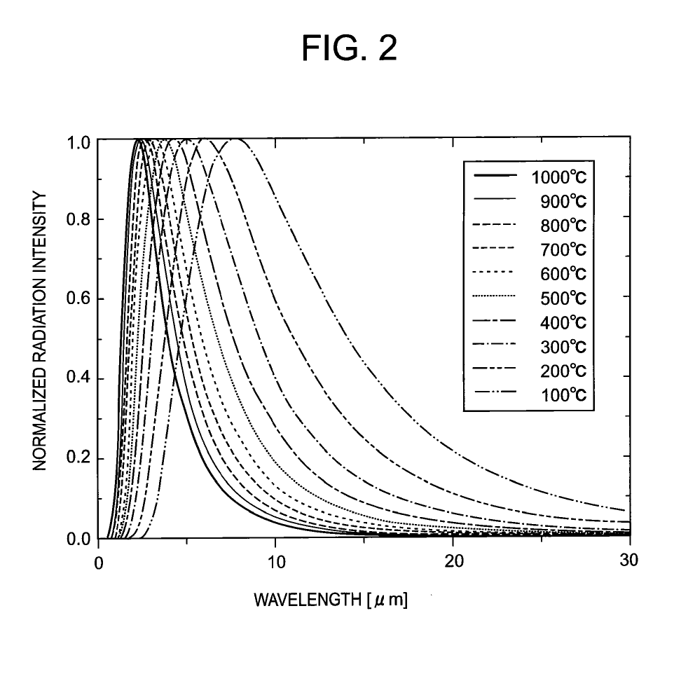

FIG. 2 shows a relation between the radiation intensity and the wavelength at the temperature of 100° C. to 1000° C. Incidentally, FIG. 2 is normalized by setting the radiation intensity B (λₘₐₓ) in the wavelength λₘₐₓ to one (1). As shown in FIG. 2, because the wavelength at which the radiation intensity becomes max is different depending on the temperature of the reaction section, materials of the reflective film 21a and the radiation transmitting windows 23, 25 need to be selected according to operation temperatures of the low temperature reaction section 13 and the high temperature reaction section 15.

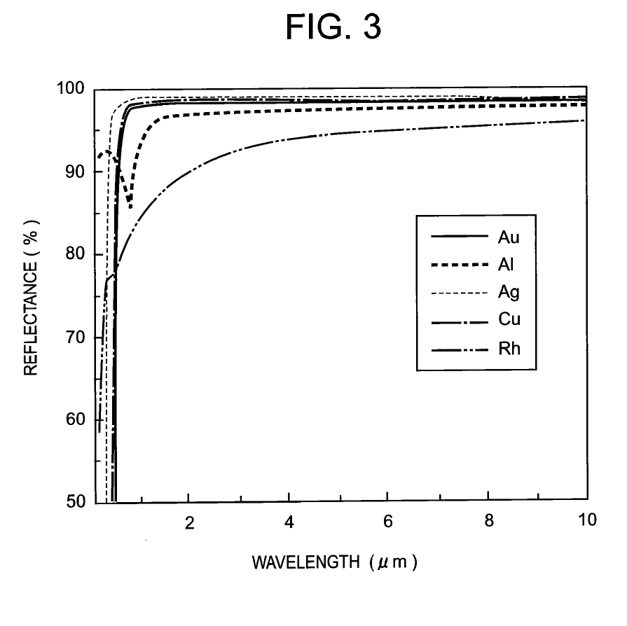

FIG. 3 is a graph showing a wavelength dependency of reflectance of the radiations of Au, Al, Ag, Cu, Rh which can be materials of the reflective film 21a. As shown in FIG. 3, Au, Al, Ag, Cu have reflectance of the radiation emitted from the reaction section of 100° C. to 1000° C., which reflectance is 90% or more in the infrared region of 1 μm or more, and may be used as the reflective film 21a.

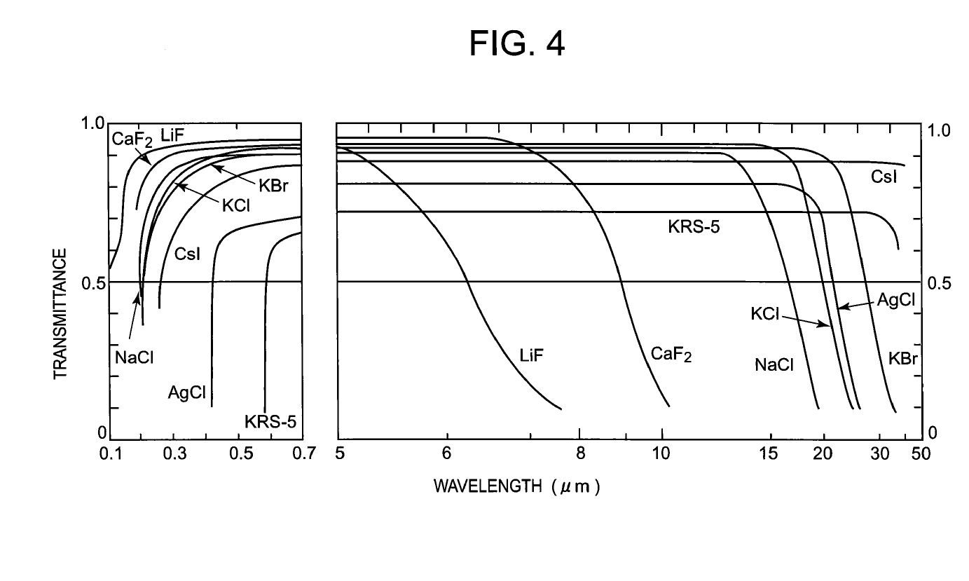

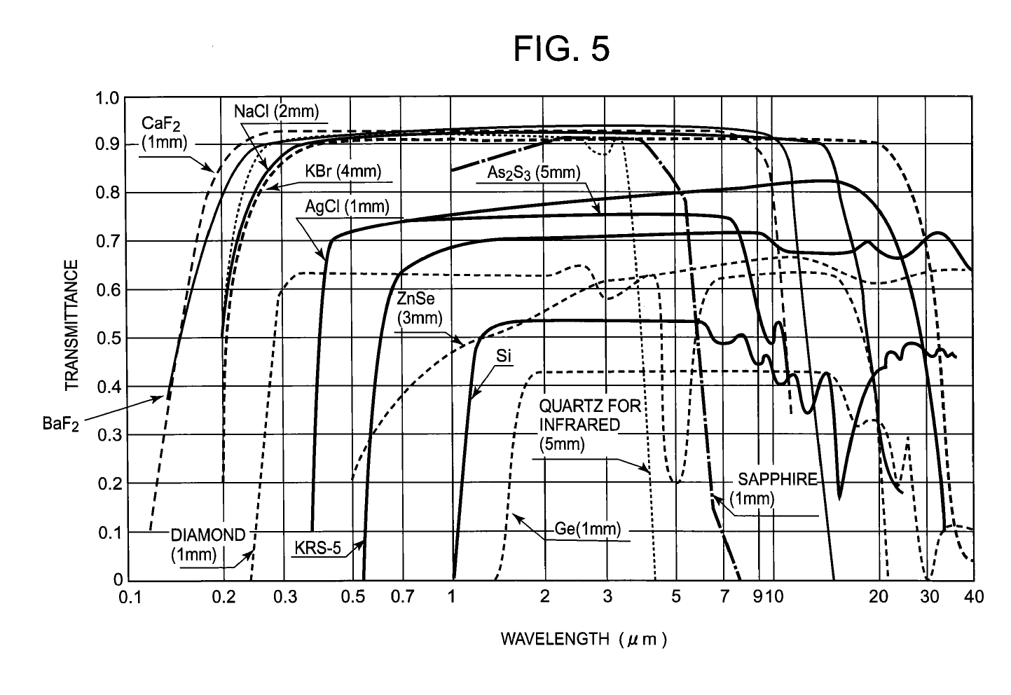

FIGS. 4, 5 are graphs showing a relation between a transmittance of substance which can be material of the radiation transmitting windows 23, 25 and a wavelength of light. As the radiation transmitting windows 23, 25, material having high transmittance for the radiation emitted from the radiation discharging films 13a, 15a may be selected. On the other hand, material having low transmittance and high absorptance for the radiation emitted from the radiation discharging films 13a, 15a is not suitable because the temperatures of the radiation transmitting windows 23, 25 rise due to absorbed radiation heat so that the heat is transmitted to the external apparatus through the heat insulating container 20.

As materials suitable for the radiation transmitting windows 23, 25, for example, CaF₂ (fluorine calcium; 0.15-12), BaF₂ (potassium fluorine; 0.25-15), ZnSe (zinc selenide; 0.6-18), MgF₂ (magnesium fluorine; 0.13-10), KRS-5 (thallium bromide-iodide; 0.6-60), KRS-6 (thallium bromide-iodide; 0.41-34), LiF (lithium fluoride; 0.11-8), SiO₂ (optical synthetic silica; 0.16-8), CsI (cesium iodide; 0.2-70), KBr (kalium bromide; 0.2-40) and the like, which are used as materials of an observation window for ultrahigh vacuum, may be used. Incidentally, numbers in parenthesis are wavelengths (μm) in transmission region.

In addition, AlF₃ (0.22-12), NaCl (0.21-26), KF (0.16-15), KCl (0.21-30), CsCl (0.19-25), CsBr (0.24-40), CsF (0.27-18), NaBr (0.22-23), CaCO₃ (0.3-5.5), KI (0.3-30), NaI (0.25-25), AgCl (0.4-30), AgBr (0.45-33), TlBr (0.9-40), Al₂O₃ (0.2-8), BiF₃ (0.26-20), CdSe (0.7-25), CdS (0.55-18), CdTe (0.86-28), CeF₃ (0.3-12), CeO₂ (0.4-16), Cr₂O₃ (1.2-10), DyF₂ (0.22-12), GaAs (0.9-18), GaSe (0.65-17), Gd₂O₃ (0.32-15), Ge (1.7-25), HfO₂ (0.23-12), La₂O₃ (0.26-11), MgO (0.23-9), NaF (0.13-15), Nb₂O₅ (0.32-8), PbF₂ (0.24-20), Si (1.1-1.4), Si₃N₄ (0.25-9), SrF₂ (0.2-10), TlCl (0.4-20), YF₃ (0.2-14), Y₂O₃ (0.25-9), ZnO (0.35-20), ZnS (0.38-14), ZrO₂ (0.3-8) and the like may be used.

As shown in above, according to the embodiment, since the radiation from the high temperature reaction section 15 or the low temperature reaction section 13 is discharged to outside of the reaction device 10A through the radiation transmitting windows 23, 25, the temperatures of the high temperature reaction section 15 and the low temperature reaction section 13 can be maintained appropriately while suppressing the heat transmission quantity from the high temperature reaction section 15 or the low temperature reaction section 13 to the heat insulating container 20.

Incidentally, though the radiation discharging films 13a, 15a are provided respectively in the low temperature reaction section 13 and the high temperature reaction section 15 in the embodiment, the radiation discharging film may be provided in only one of the reaction sections. Moreover, only one of the radiation transmitting windows 23, 25 facing the provided radiation discharging film may be provided. Furthermore, the chassis 21 may be formed of material allowing the radiation in the infrared region to transmit and the radiation transmitting windows 23, 25 may be integrated in the chassis 21.

### <Variation 1>

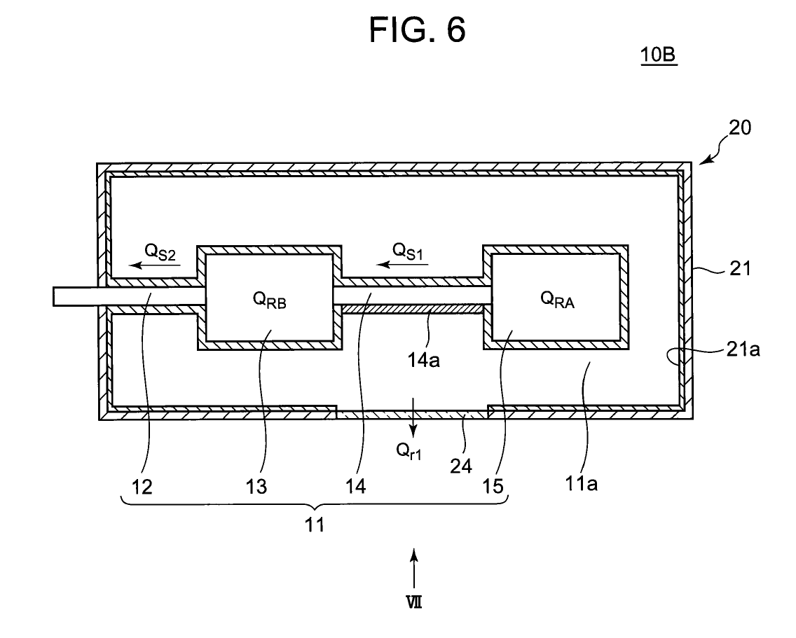

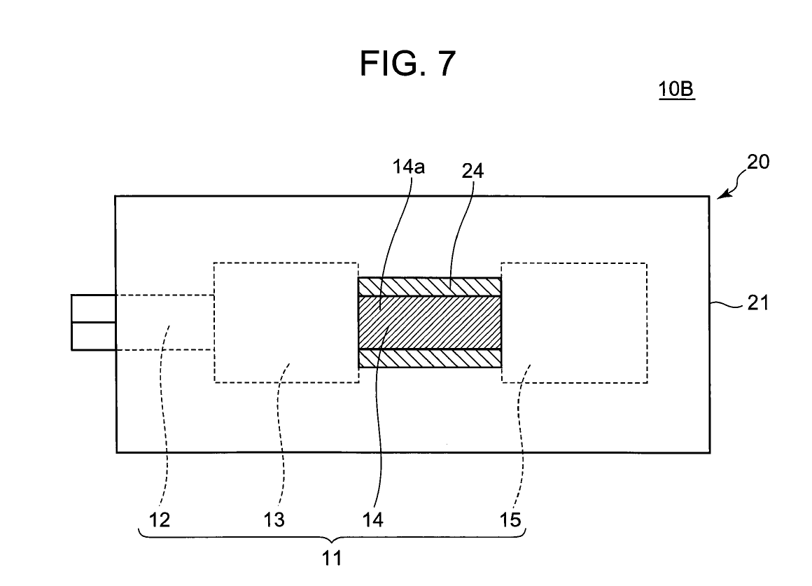

FIG. 6 is a schematic diagram showing a configuration of a reaction device 10B according to a first variation of the present invention, and FIG. 7 is a view on arrow VII of FIG. 6. Incidentally, as for same configurations as the first embodiment, explanations are omitted by adding same reference numbers to last two digits.

The reaction device according to the variation discharges the radiation at the second connecting section 14, not at the high temperature reaction section 15, by providing a radiation discharging film 14a at the second connecting section 14 and providing the radiation transmitting window 24 at a portion of the heat insulating container 20 facing the radiation discharging film 14a. In this case, when it is supposed that a heat budget by heat transfer between reaction heat inside the high temperature reaction section 15 and flowing gas is Q_{RA}, a heat budget inside the low temperature reaction section 13 is Q_{RB}, heat discharge amount by the radiation discharging film 14a is Qᵣ₁, the following formulas (7), (8) are satisfied in a condition of thermal equilibrium.

### [Formula 6]

Q_{RA}−Q_{S1}−Qᵣ₁=0 (7)

Q_{RB}+Q_{S1}−Q_{S2}=0 (8)

According to the formulas (7), (8), a total heat budgets of the low temperature reaction section 13 and the high temperature reaction section 15 is a sum of Qᵣ₁ and Q_{S2}. Also in this variation, similar to the first embodiment, by setting the heat discharge amount Qᵣ₁ property depending on the total heat budget in the reaction sections 13, 15 and the suppressed heat transmission quantity Q_{S2} to the heat insulating container, it is possible to suppress the heat transmission quantity Q_{S2} to the external apparatus while maintaining the temperature of each of the reaction sections 13, 15 at a proper temperature.

Incidentally, when the heat budgets Q_{RA}, Q_{RB} in the reaction sections and the heat transmission quantity Q_{S2} to the heat insulating container of this variation are same as those of the first embodiment, the heat transmission quantity from the high temperature reaction section 15 to the second connecting section 14 is Q_{RA}-Q₁ in the first embodiment, while it is Q_{RA} in this variation. Thus, the heat transmission quantity of this variation is larger than that of the first embodiment. On the other hand, according to the formula (1), when the heat conductivity k, the cross-section area S and the temperature difference ΔT are constant respectively, the larger the heat transmission quantity Q_{S2} the smaller the heat transfer length Δx. Therefore, when the radiation is not discharged in the high temperature reaction section 15 like this variation, a pipe length in the second connecting section 14 can be shortened in comparison with the case where the radiation is discharged in the high temperature reaction section 15, and thereby the reaction device body 11 and the reaction device 10B can be downsized.

Moreover, the radiation may be discharged in both of the high temperature reaction section 15 and the second connecting section 14. In this case, when it is supposed that a heat budget by heat transfer between reaction heat inside the high temperature reaction section 15 and flowing gas is Q_{RA}, a heat budget inside the low temperature reaction section 13 is Q_{RB}, heat discharge amount by the radiation discharging film 14a is Qᵣ₁, the following formulas (9), (10) are satisfied in a condition of thermal equilibrium.

### [Formula 7]

Q_{RA}−Q₁−Q_{S1}−Qᵣ₁=0 (9)

Q_{RB}+Q_{S1}−Q_{S2}=0 (10 )

In this case, although the heat transmission quantity from the high temperature reaction section 15 to the second connecting section 14 is Q_{RA}-Q₁, the radiation is discharged also in the second connecting section 14 so that Q₁ can be set smaller than that of the first embodiment. Therefore, heat transmission quantity from the high temperature reaction section 15 to the second connecting section 14 can be larger than that of the first embodiment, and similar to this variation, the reaction device body 11 and the reaction device 10B can be downsized by shortening the pipe length of the second connecting section 14.

### <Variation 2>

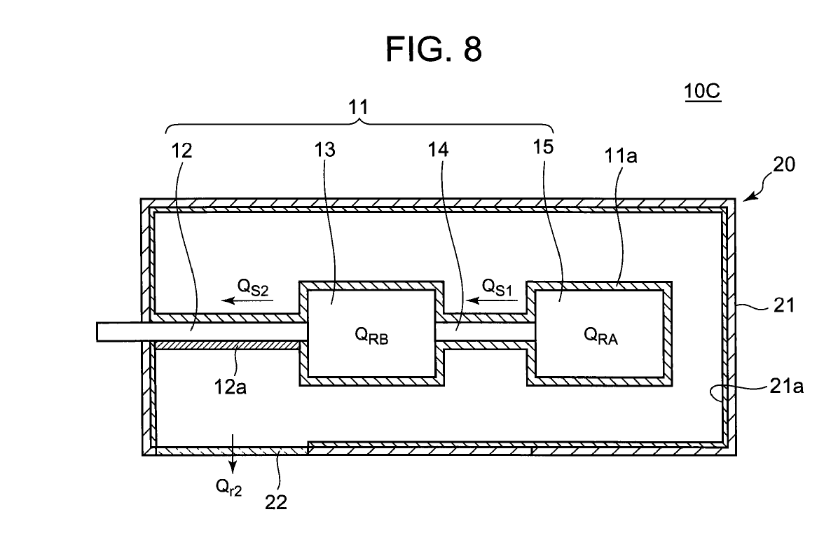

FIG. 8 is a schematic diagram showing a configuration of a reaction device 10C according to a second variation of the present invention. Incidentally, as for same configurations as the first embodiment, explanations are omitted by adding same reference numbers to last two digits.

The reaction device according to this variation discharges the radiation in the first connecting section 12, not in the reaction sections 13, 15, by providing the radiation discharging film 12a at a portion between the low temperature reaction section 13 of the first connecting section 12 and the heat insulating container 20 and providing the radiation transmitting window 22 at a portion facing the radiation discharging film 12a in the heat insulating container 20. In this case, when it is supposed that a heat budget by heat transfer between reaction heat inside the high temperature reaction section 15 and flowing gas is Q_{RA}, a heat budget inside the low temperature reaction section 13 is Q_{RB}, and heat discharge amount by the radiation discharging film 12a is Qᵣ₂, the following formulas (11), (12) are satisfied in a condition of thermal equilibrium.

### [Formula 8]

Q_{RA}−Q_{S1}=0 (11)

Q_{RB}+Q_{S1}−Q_{S2}−Qᵣ₂ =0 (12)

Incidentally, when the heat budgets Q_{RA}, Q_{RB} in the reaction sections and the heat transmission quantity Q_{S2} to the heat insulating container of this variation are same as those of the first embodiment, the heat transmission quantity from the low temperature reaction section 13 to the first connecting section 12 is Q_{RB}-Q_{II}+Q_{S1} in the first embodiment, while it is Q_{RB}+Q_{S1} in this variation, according to the formulas (11), (12). Thus, the heat transmission quantity of this variation is larger than that of the first embodiment. Therefore, similar to the above-described variation 1, when the radiation is not discharged in the reaction sections 13, 15 like this variation, a pipe length in the second connecting section 12 can be shortened in comparison with the case where the radiation is discharged in the high temperature reaction section 15 like the first embodiment, so that the reaction device body 11 and the reaction device 10C can be downsized.

### <Variation 3>

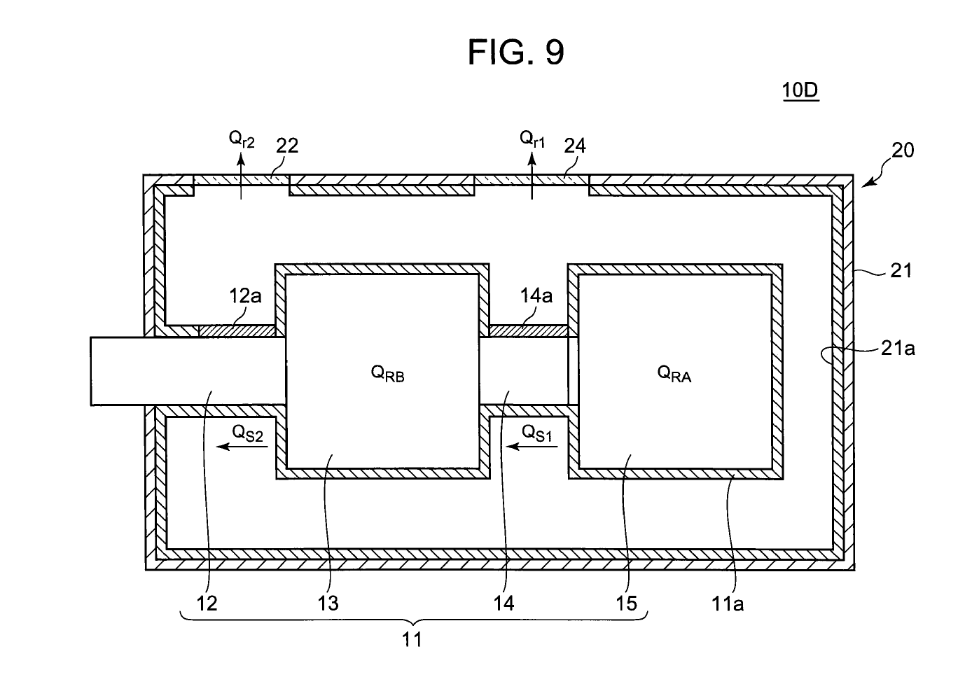

FIG. 9 is a schematic diagram showing a configuration of a reaction device 10D according to a third variation of the present invention. Incidentally, as for same configurations as the first embodiment, explanations are omitted by adding same reference numbers to last two digits.

The reaction device according to this variation discharges the radiation in the first connecting section 12 and the second connecting section 14, not at the reaction sections 13, 15, by providing the radiation discharging film 12a at a portion between the low temperature reaction section 13 of the first connecting section 12 and the heat insulating container 20, providing the radiation transmitting window 22 at a portion facing the radiation discharging film 12a in the heat insulating container 20, providing the radiation discharging film 14a at the second connecting section 14, and providing the radiation transmitting window 24 at a portion facing the radiation discharging film 14a in the heat insulating container 20. In this case, when it is supposed that a heat budget by heat transfer between reaction heat inside the high temperature reaction section 15 and flowing gas is Q_{RA}, a heat budget inside the low temperature reaction section 13 is Q_{RB}, heat discharge amount by the radiation discharging film 12a is Qᵣ₂, and heat discharge amount by the radiation discharging film 14a is Qᵣ₁, the following formulas (13), (14) are satisfied in a condition of thermal equilibrium.

### [Formula 9]

Q_{RA}−Q_{S1}−Qᵣ₁=0 (13)

Q_{RB}+Q_{S1}−Q_{S2}−Qᵣ₂=0 (14)

Incidentally, when the heat budgets Q_{RA}, Q_{RB} in the reaction sections and the heat transmission quantity Q_{S2} to the heat insulating container of this variation are same as those of the first embodiment, the heat transmission quantity from the high temperature reaction section 15 to the second connecting section 14 is Q_{RA}-Q_{I} in the first embodiment, while it is Q_{RA} in this variation, according to the formulas (13), (14). Thus, the heat transmission quantity of this variation is larger than that of the first embodiment. Moreover, the heat transmission quantity from the low temperature reaction section 13 to the first connecting section 12 is Q_{RB}-Q_{II} in the first embodiment, while it is Q_{RB} in this variation. Thus, the heat transmission quantity of this variation is larger than that of the first embodiment. Therefore, similar to each of the above variations, when the radiation is not discharged in the reaction sections 13, 15 like this variation, pipe lengths in the first connecting section 12 and the second connecting section 14 can be shortened in comparison with the case where the radiation is discharged in the reaction sections 13, 15 like the first embodiment, so that the reaction device body 11 and the reaction device 10D can be downsized.

Moreover, the radiation may be discharged in each section of the first connecting section 12, the low temperature reaction section 13, the second connecting section 14 and the high temperature reaction section 15. In this case, when it is supposed that a heat budget by heat transfer between reaction heat inside the high temperature reaction section 15 and flowing gas is Q_{RA}, a heat budget inside the low temperature reaction section 13 is Q_{RB}, heat discharge amount by the radiation discharging film 12a is Qᵣ₂, and heat discharge amount by the radiation discharging film 14a is Qᵣ₁, the following formulas (15), (16) are satisfied in a condition of thermal equilibrium.

### [Formula 10]

Q_{RA}−Q_{I}−Q_{S1}−Qᵣ₁=0 (15)

Q_{RB}+Q_{S1}−Q_{II}−Qᵣ₂−Q_{S2}=0 (16)

In this case, though the heat transmission quantity from the high temperature reaction section 15 to the second connecting section 14 is Q_{RA}-Q_{I}, since the radiation is discharged also in the second connecting section 14, Q_{I} can be set to be smaller than that of the first embodiment. Moreover, tough the heat transmission quantity from the low temperature reaction section 13 to the first connecting section 12 is Q_{RB}-Q_{II}, since the radiation is discharged also in the first connecting section 12, Q_{II} can be set to be smaller than that of the first embodiment. Therefore, the heat transmission quantity from the high temperature reaction section 15 to the second connecting section 14 and the heat transmission quantity from the low temperature reaction section 13 to the first connecting section 12 can be larger than those of the first embodiment so that similar to variation 1, pipe lengths in the second connecting section 14 and the first connecting section 12 may be shortened, thereby the reaction device body 11 and the reaction device 10D may be downsized.

### Second Embodiment

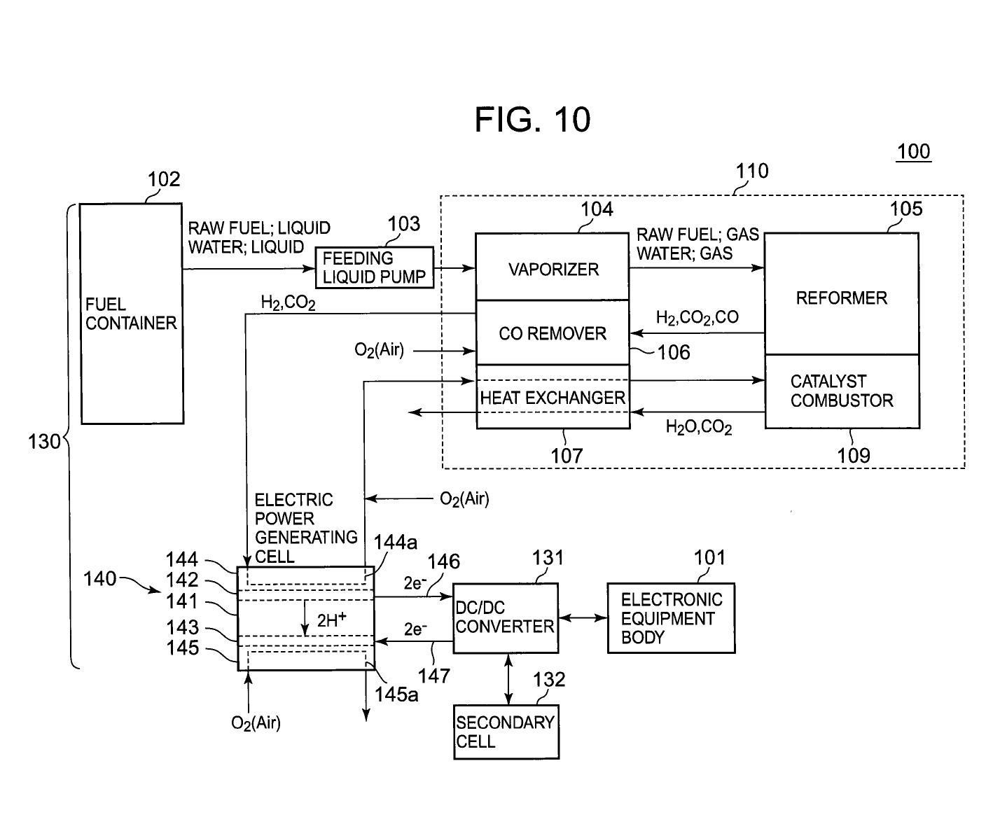

Next, a second embodiment of the present invention will be explained. FIG. 10 is a block diagram showing electronic equipment 100 according to a second embodiment of the present invention. The electronic equipment 100 is portable equipment such as a note-book sized personal computer, PDA, electronic notepads, digital camera, cellular phone, wrist watch and game instrument.

The electronic equipment 100 is roughly composed of a fuel cell device 130, an electronic equipment body 101 to which the fuel cell device 130 supplies an electric power and the like. The fuel cell device 130 produces an electric power to supply it to the electronic equipment body 101 as described later.

Next, the fuel cell device 130 will be explained. The fuel cell device 130 produces an electric power to be output to the electronic equipment body 101, and includes a fuel container 102, a liquid feeding pump 103, the reaction device 110, a fuel cell 140, DC/DC converter 131, a secondary cell 132, and so on.

The fuel container 102 reserves a mixed liquid of liquid raw fuel (for example, methanol, ethanol, and dimethyl ether) and water. Incidentally, the liquid raw fuel and the water may be separately reserved in the fuel container 102.

The mixed liquid in the fuel container 102 is sent to the vaporizer 104 of the reaction device 110 by the liquid feeding pump 103.

The reaction device 110 is composed of the vaporizer 104, a reformer 105, a carbon monoxide remover 106, a heat exchanger 107, a catalyst combustor 109 and the like.

The vaporizer 104 heats the mixed liquid sent from the fuel container 102 to about 110-160° C. by heat transmission from a heater/temperature sensor 153 described later or the reformer 105 to vaporize the mixed liquid. The mixed gas vaporized in the vaporizer 104 is sent to the reformer 105.

The reformer 105 includes a flow path formed inside, and a reforming catalyst is formed on a wall surface of the flow path. As the reforming catalyst, Cu/ZnO catalyst, Pd/ZnO catalyst and the like may be used. The reformer 105 heats the mixed gas sent from the vaporizer 104 to about 300-400° C. by heat transmission from the heater/temperature sensor 155 described later to cause a reforming reaction by the catalyst inside the flow path. In other words, by a catalytic reaction of the raw fuel and the water, a mixed gas (reformed gas) including hydrogen as a fuel, carbon dioxide, and a small amount of carbon monoxide as a by-product is produced.

Incidentally, when the raw fuel is methanol, a vapor reforming reaction as a main reaction as shown in the following chemical reaction formula (17) mainly occurs in the reformer 105.

CH₃OH+H₂O→3H₂+CO₂ (17)

In addition, by a side reaction like the following chemical reaction formula (18) sequentially occurs after the chemical reaction formula (17), a small amount (about 1%) of carbon monoxide is produced as a by-product.

H₂+CO₂→H₂O+CO (18)

Products (reformed gas) by the reactions of the chemical reaction formulas (17), (18) are sent to the carbon monoxide remover 106.

The carbon monoxide remover 106 includes a flow path formed inside, and a selective oxidation catalyst to selectively oxidize the carbon monoxide is supported by a wall surface of the flow path. As the selective oxidation catalyst, for example, Pt/Al₂O₃ may be used.

The reformed gas produced in the reformer 105 and outside air are sent to the carbon monoxide remover 106. The reformed gas is mixed with the air to flow the flow path in the carbon monoxide remover 106 to be heated to 110-160° C. by heat transmission from the reformer 105 or the heater/temperature sensor 155. Then, the carbon monoxide included in the reformed gas is preferentially oxidized by the catalyst as a main reaction as the following chemical reaction formula (19). By this, the carbon dioxide is produced as a main product, and concentration of the carbon monoxide in the reformed gas can be lowered to about 10 ppm capable of supplying to the fuel cell 140.

2CO+O₂→2CO₂ (19)

Since the reaction of the chemical reaction formula (19) is an exothermic reaction, the carbon monoxide remover 106 is located next to the vaporizer 104 wherein an endothermic reaction (vaporization of mixed liquid) is performed.

The reformed gas passing through the carbon monoxide remover 106 is sent to the fuel cell 140.

The reformed gas (off gas) passing through a fuel feeding flow path 144a of the fuel cell 140 and the air are sent to the catalyst combustor 109, and the hydrogen remaining in the reformed gas is combusted with the air. The heat exchanger 107 is located next to the carbon monoxide remover 106, and heats the off gas and the air by heat of the carbon monoxide remover 106 when the off gas and the air to be supplied to the catalyst combustor 109 are passing through.

The fuel cell 140 is a polymer electrolyte fuel cell wherein a solid polyelectrolyte film 141, a fuel electrode 141 (anode) and an oxygen electrode 143 (cathode) which are formed both sides of the solid polyelectrolyte film 141, a fuel electrode separator 144 wherein the fuel feeding flow path 144a for supplying the reformed gas to the fuel electrode 142 is formed, an oxygen electrode separator 145 wherein an oxygen feeding flow path 145a for supplying the oxygen to the oxygen electrode 143 are laminated.

The solid polyelectrolyte film 141 has a property of being transmitted through by hydrogen ion and not being transmitted through by oxygen molecule, hydrogen molecule, carbon dioxide, or electron.

The reformed gas is sent to the fuel electrode 142 through the fuel feeding flow path 144a. A reaction shown in the following electrochemical reaction formula (20) by the hydrogen in the reformed gas occurs in the fuel electrode 142.

H₂→2H⁺+2e⁻ (20)

The produced hydrogen ion transmits through the solid polyelectrolyte film 141 to reach the oxygen electrode 143. The generate electron is supplied to an anode output electrode 146.

The air is sent to the oxygen electrode 143 through the oxygen feeding flow path 145a. In the oxygen electrode 143, water is produced by the hydrogen ion which has transmitted through the solid polyelectrolyte film 141, the oxygen in the air and the electron supplied from a cathode output electrode 147, as shown in the following electrochemical reaction formula (21).

2H⁺+1 /2O₂+2e⁻→H₂O (21)

Incidentally, on both sides of the solid polyelectrolyte film 141, a not-shown catalyst for stimulating the reactions shown in the electrochemical reaction formulas (20), (21) is provided.

The anode output electrode 146 and the cathode output electrode 147 are connected to the DC/DC converter 131 as an external circuit so that the electron reaching to the anode output electrode 146 is supplied to the cathode output electrode 147 through the DC/DC converter 131.

The DC/DC converter 131 converts the electric power produced by the fuel cell 140 to the proper voltage to supply it to the electric equipment body 101, and charges the secondary cell 132 with the electric power.

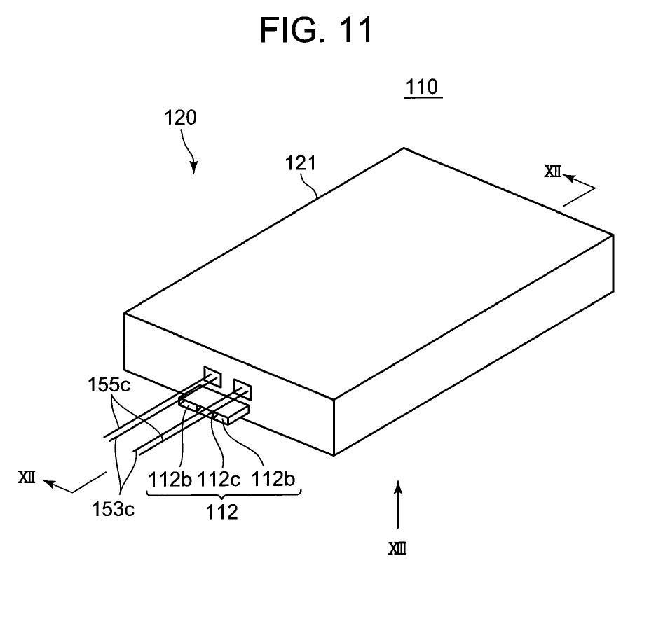

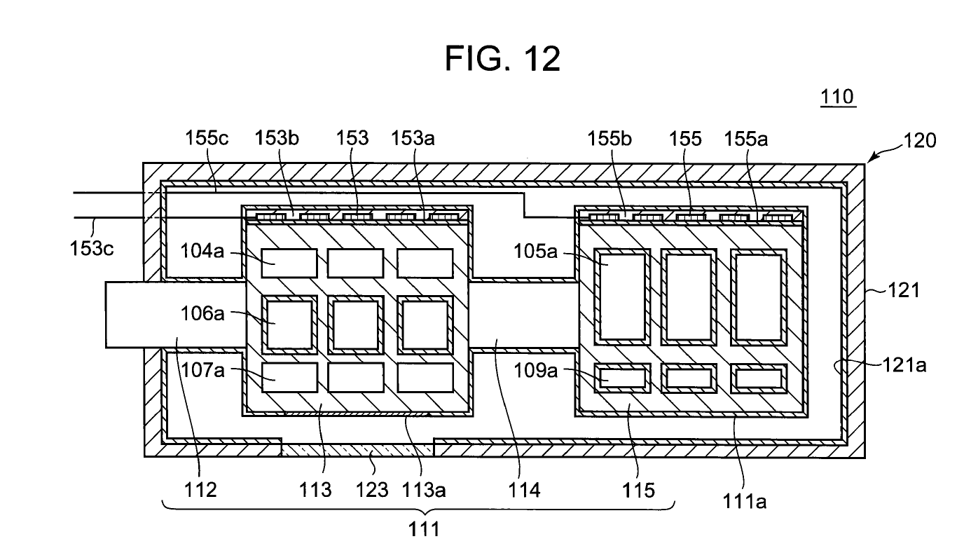

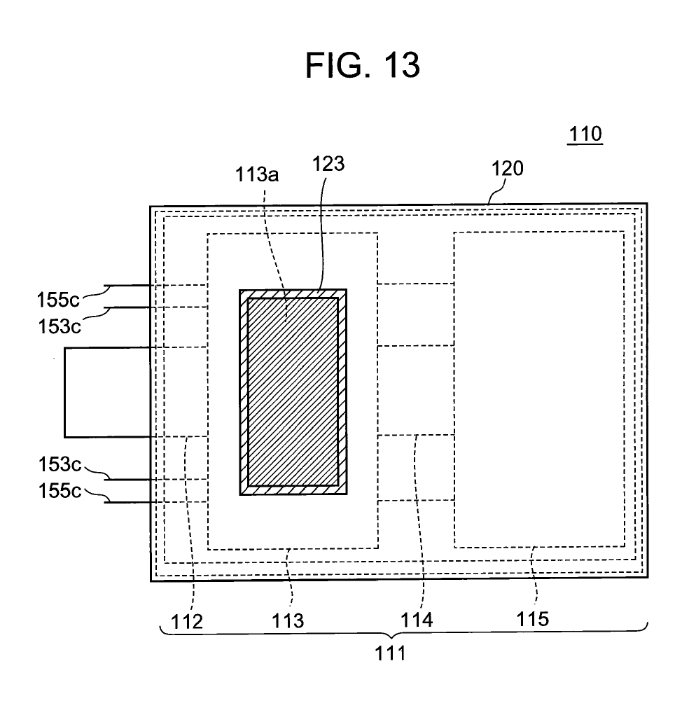

Next, a configuration of the reaction device 110 will be explained. FIG. 11 is a perspective diagram of the reaction device 110, FIG. 12 is a schematic cross-section diagram corresponding to a cutting-plane line XII-XII in FIG. 11, and FIG. 13 is a view on arrow XIII of FIG. 11. The reaction device 110 includes the reaction device body 111 and the heat insulating container (first container) 120 to house the reaction device body 111. Incidentally, as for same configurations as the first embodiment, explanations are omitted by adding same reference numbers to last two digits. In addition, as lead wires 153c, 155c, one lead wire on high voltage side or low voltage side is shown in FIG. 12. Although the lead wires 153c, 155c are shown not to overlap each other in FIG. 12 for showing simply, they may practically overlap each other when viewed from the side.

The reaction device body 111 is composed of the first connecting section 112, the low temperature reaction section 113, the second connecting section 114, and the high temperature reaction section 115.

The high temperature reaction section 115 includes a reforming flow path 105a to be the reformer 105 and a catalyst combusting flow path 109a to be the catalyst combustor 109. Moreover, the high temperature reaction section 115 is provided with the heater/temperature sensor 155, and is maintained at about 300-400° C. by the heater/temperature sensor 155. The heater/temperature sensor 155 is connected to the lead wire 155c penetrating the heat insulating container 120. The electric power is supplied from outside of the heat insulating container 120 to the heater/temperature sensor 155 through the lead line 155c. The heater/temperature sensor 155 is insulated from other members by insulating films 155a, 155b.

The low temperature reaction section 113 is composed of a vaporizing flow path 104a to be the vaporizer 104, a carbon monoxide removing flow path 106a to be the carbon monoxide remover 106, and a heat exchanging flow path to be the heat exchanger 107. Moreover, the low temperature reaction section 113 includes an electric heat/temperature sensor 153, and is maintained at about 110-160° C. by the electric heat/temperature sensor 153. The electric heat/temperature sensor 153 is connected to the lead wire 153c penetrating the heat insulating container 120. The electric power is supplied from outside of the heat insulating container 120 to the electric heat/temperature sensor 153 through the lead wire 153c. The electric heat/temperature sensor 153 insulated from other members by the insulating films 153a, 153b.

The first connecting section 112 contains a pipe to be a flow path through which a reactant to be react in the high temperature reaction section 115 and the low temperature reaction section 113 and a produced product. The first connecting section 112 is connected to the low temperature reaction section 113 at one end, penetrates the heat insulating container 120 on the other end side, and is connected to the liquid feeding pump 103, the fuel cell 140, a not-shown air pump and the like at the other end. Moreover, the first connecting section 112 includes a first pipe (outflow pipe) 112b to be the flow path through which the reactant and the product is sent from the low temperature reaction section 113 to outside of the heat insulating container 120, and a second pipe (inflow pipe) 112c to send the reactant and the product from outside of the heat insulating container 120 to the low temperature reaction section 113.

The second connecting section 114 includes a pipe through which the reactant to react in the high temperature reaction section 115 and the low temperature reaction section 113 and the produced product flow, and connects the high temperature reaction section 115 and the low temperature reaction section 113. Moreover, the second connecting section 114 is connected to the high temperature reaction section 115 at one end, connected to the low temperature reaction section 113 at the other end, and includes a third pipe (outflow pipe) 114b to be the flow path through which the reactant and the product is sent from the high temperature reaction section 115 to the low temperature reaction section 113 and a fourth pipe (inflow pipe) 114c through which the reactant and the product is sent from the low temperature reaction section 113 to the high temperature reaction section 115. Incidentally, the first pipe and the second pipe may be integrally provided or put together so as to easily perform heat exchange between the first pipe and the second pipe. In this case, for example, by dividing the first pipe into two pipes to place each of the pipes around the second pipe, the heat exchange between the first pipe and the second pipe becomes likely to be performed. The same can be said for the third pipe and the fourth pipe.

In this embodiment, as shown in FIG. 12, the radiation discharging film 113a is provided in the low temperature reaction section 113, and the radiation transmitting window 123 is provided at the portion facing the radiation discharging film 113a in the heat insulating container 120. Since the radiation from the radiation discharging film 113a transmits though the radiation transmitting window 123, a part of heat quantity produced in the low temperature reaction section 113 is discharged to outside of the heat insulating container 120 by the radiation. Therefore, the heat quantity conducted from the low temperature reaction section 113 to the heat insulating container 120 through the first connecting section 112 can be suppressed, and the temperature of the low temperature reaction section 113 can be prevented from rising more than necessary due to the heat transmission from the high temperature reaction section 115 to be maintained at proper temperature.

In the configuration according to the embodiment, an advantage when the temperature of the low temperature reaction section 113 is 150° C., the temperature of the high temperature reaction section 115 is 400° C., an efficiency of the fuel cell 140 is 40% and electricity generated is 20 W will be calculated.

Heat budgets (sum of reaction heat of each of the chemical reactions and heat exchange of the reaction gas) of the high temperature reaction section 115 and the low temperature reaction section 113 except heat transmission by the second connecting section 114 or the first connecting section 112 are +2 W, +9 W respectively. When the radiation discharging film 113a and the radiation transmitting window 123 are not provided, the total quantity of 11 W is conducted to the heat insulating container 120. For example, by discharging 9 W by the radiation discharging film 113a through the radiation transmitting window 123, the heat quantity conducted from the first connecting section 112 can be suppressed to 2 W. When the emissivity of the radiation discharging film 113a is one (1) and the radiation transmitting window 123 is formed by BaF₂, 9 W can be discharged by making a surface area of the radiation discharging film 113a be about 50 cm².

Incidentally, the temperature of the low temperature reaction section 113 having the vaporizer 104 is about 150° C., and it is preferable that the radiation of wavelength region within 3.0-23 μm transmits through. In this case, any of the above-described materials may be used as the material of the radiation transmitting window 123, and especially KRS-5, KRS-6, CsI, KBr, NaCl, KCl, CsCl, CsBr, NaBr, KI, NaI, AgCI, AgBr, TlBr, CdSe, CdTe, and Ge may be preferably used in view of transmittance in the wavelength region. Moreover, for example, when the heat is discharged from the high temperature reaction section 115 having the reformer 105 at about 400° C., it is preferable that the radiation of wavelength within 2.2-17 μm transmits through. In this case, any of the above-described materials may be used as the material of the radiation transmitting window 125, and especially ZnSe, KRS-5, KRS-6, CsI, KBr, NaCl, KCl, CsCl, CsBr, CsF, NaBr, KI, NaI, AgCl, AgBr, TlBr, BiF₃, CdSe, CdS, CdTe, GaAs, GaSe, Ge, NaF, PbF₂, TlCl, YF₃, ZnO may be preferably used in view of transmittance in the wavelength region.

As described above, according to the embodiment, the materials of the radiation discharging film 113a and the radiation transmitting window 123 may be selected appropriately depending on the heat radiation amount or the temperature of the radiation discharging region. Moreover, the areas of the radiation discharging film 113a and the radiation transmitting window 123 may be changed appropriately depending on the heat radiation amount, and conversely, when installation areas thereof are restricted, the materials of the radiation discharging film 113a and the radiation transmitting window 123 may be changed depending on the restriction. In addition, the above calculated values are values when the heat exchange is not performed between the first pipe and the second pipe or between the third pipe and the fourth pipe, and the case where the emissivity is one (1) meas the case where the emissivity obtained by integration in whole wavelength region is one (1) Moreover, though the above-described wavelength region preferable to transmit through is allowed to be a wavelength region where the normalized radiation intensity becomes 0.1 or more, the wavelength may be changed appropriately, and additionally, the material of the radiation transmitting window corresponding to the changed wavelength region may be selected.

### Third Embodiment

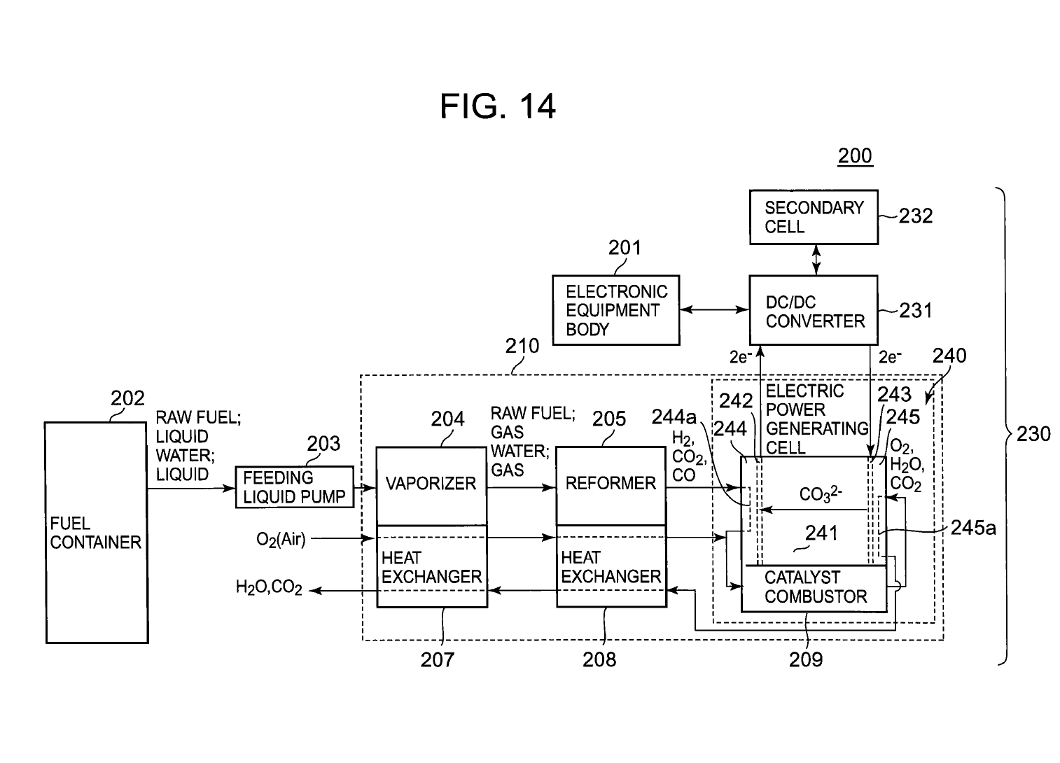

Next, a third embodiment of the present invention will be explained. FIG. 14 is a block diagram showing electronic equipment 200 according to the third embodiment of the present invention. Incidentally, as for same configurations as the second embodiment, explanations are omitted by adding same reference numbers to last two digits.

In the embodiment, the reaction device 210 includes: a vaporizer 204; a reformer 205; a first heat exchanger 207; a second heat exchanger 208; a catalyst combustor 209; a fuel cell stuck 240 and the like.

The vaporizer 204 and the first heat exchanger 207 are integrally provided, the reformer 205 and the second heat exchanger 208 are integrally provided, and the fuel cell stuck 240 and the catalyst combustor 209 are integrally provided.

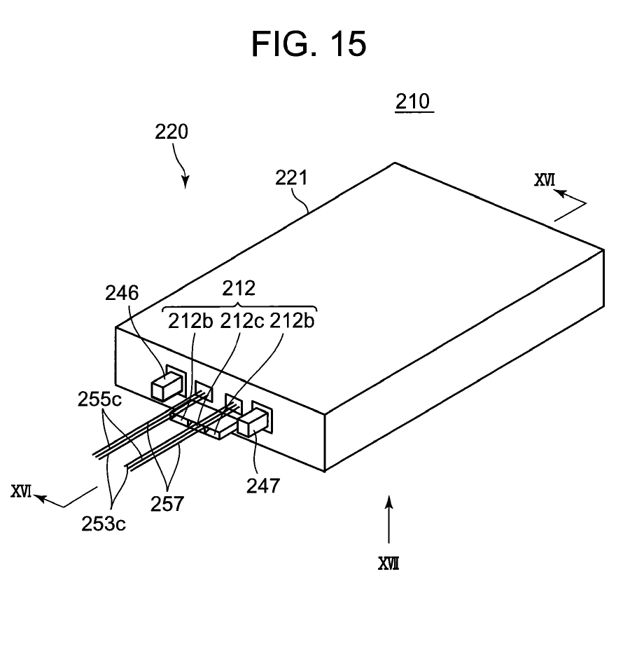

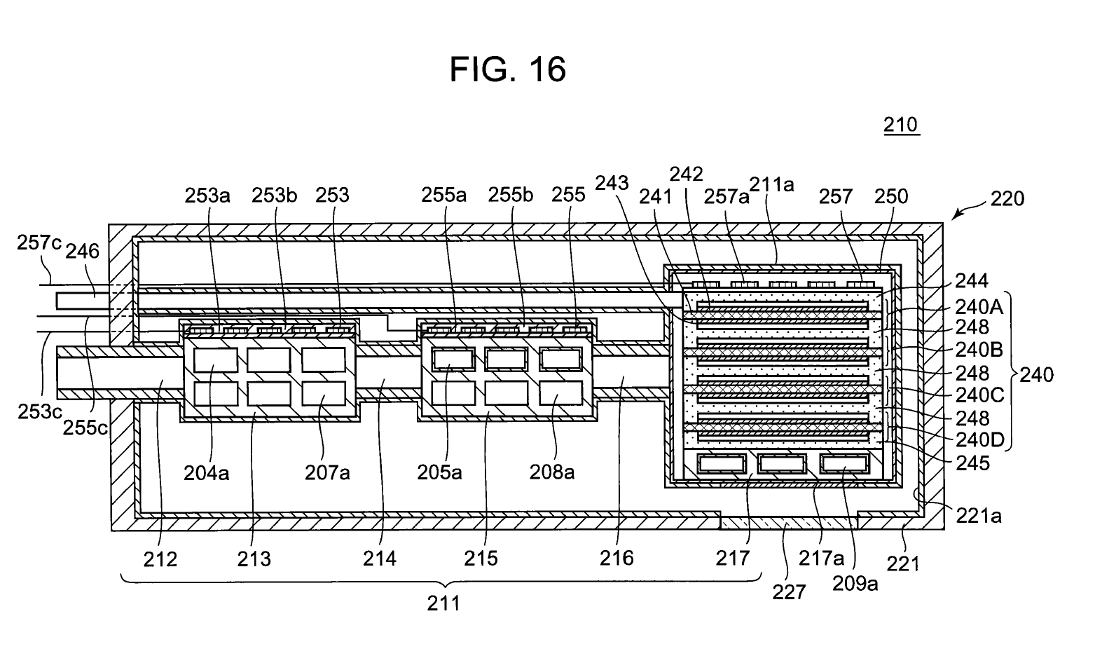

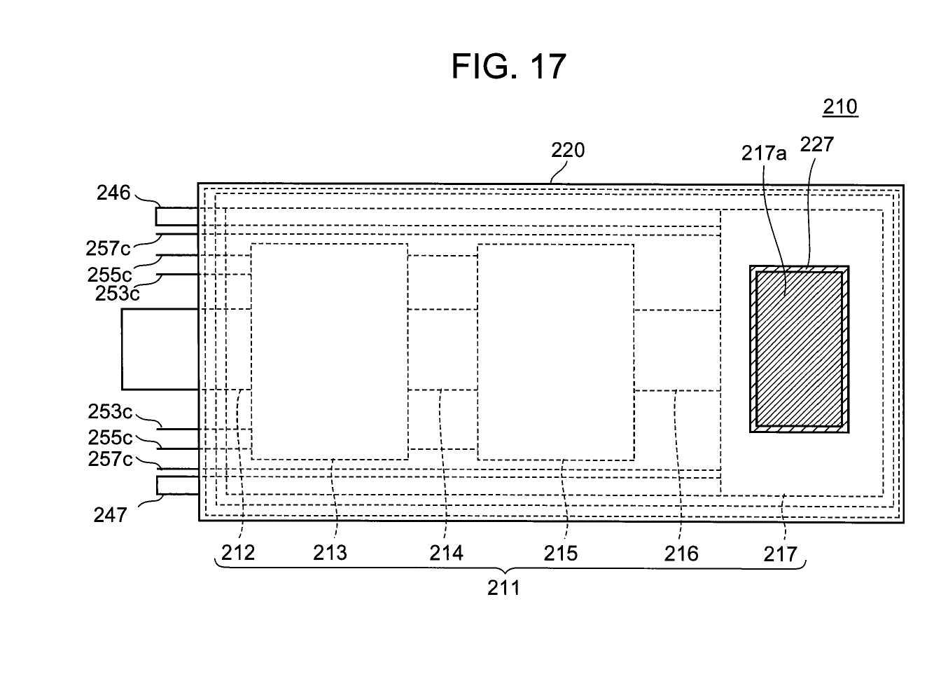

FIG. 15 is a perspective diagram of the reaction device 210, FIG. 16 is a schematic cross-section diagram corresponding to a cutting-plane line XVI-XVI in FIG. 15, and FIG. 17 is a view on arrow XVII of FIG. 15. As shown in FIG. 16, the fuel cell stuck 240 is configured by laminating a plurality of the fuel cells 240A, 240B, 240C, 240D. Incidentally, the fuel cells 240A, 240B, 240C, 240D are molten carbonate fuel cells, and not using the carbon monoxide remover. The integrated fuel cell stuck 240 and the catalyst combustor 209 is house in an airtight container (second container) 250, and the airtight container 250 is housed in the heat insulating container (first container) 220. The airtight container 250 is a container for preventing the gas from flowing in and out of a space separated by the airtight container 250, and portions through which the anode output electrode 246 and the cathode output electrode 247, and the lead wire 257c and the third connecting section 216 penetrate are air-tightened. Incidentally, each of the output electrodes and the lead wires is insulated from other members by not-shown insulating material such as glass and ceramic to be pulled out.

Incidentally, in FIG. 14, only single fuel cell 240A among the plurality of fuel cells 240A, 240B, 240C, 240D is shown, and alphabets in last digit of the reference numbers are omitted. In addition, though lead wires 253c, 255c, 257c are shown not to overlap one another in FIG. 16 for showing simply, they may practically overlap one another when viewed from the side. Moreover, in FIG. 16, as for the lead wires 253c, 255c, 257c, only one wire on high voltage side or low voltage side is shown, and the cathode output electrode 247 is not shown.

Reactions occurring in the single fuel cell 240 and the catalyst combustor 209 will be explained below.

The fuel cell 240 is configured by laminating an electrolyte 241, a fuel electrode 242 (anode) and a oxygen electrode 243 (cathode) formed on both sides of the electrolyte 241, a fuel electrode separator 244 provided with a fuel feeding flow path 244a for supplying the reformed gas to the fuel electrode 242, and an oxygen separator 245 provided with an oxygen feeding flow path 245a for supplying the oxygen to the oxygen electrode 243.

The electrolyte 241 has a property of being transmitted through by carbonate ion and not being transmitted through by oxygen molecule, hydrogen molecule, carbon monoxide, carbon dioxide, or electron.

The reformed gas is sent to the fuel electrode 242 through the fuel feeding flow path 244a. In the fuel electrode 242, reactions shown in the following electrochemical reaction formulas (22), (23) by the hydrogen in the reformed gas, carbon monoxide and the carbonate ion which has transmitted through the electrolyte 241 occur.

H₂+CO₃²⁻→H₂O+CO₂+2e⁻ (22)

CO+CO₃²⁻→2CO₂+2e⁻ (23)

The produced electron is supplied to the anode output electrode 246. The mixed gas (off gas) including the produced water, carbon dioxide, unreacted hydrogen and carbon monoxide is supplied to the catalyst combustor 209.

The oxygen (air) heated by the first heat exchanger 207 and the second heat exchanger 208 and the off gas are mixed to be supplied to the catalyst combustor 209. In the catalyst combustor 209, the hydrogen and the carbon monoxide are combusted so that combustion heat is used for heating the fuel cell stuck 240.

An exhaust gas (mixed gas of the water, oxygen and carbon dioxide) of the catalyst combustor 209 is supplied to the oxygen electrode 243 through the oxygen feeding flow path 245a.

In the oxygen electrode 243, a reaction shown in the following electrochemical reaction formula (24) occurs by the oxygen supplied from the oxygen feeding flow path 245a, the carbon monoxide, and the electron supplied from the cathode output electrode 247.

2CO₂+O₂+4e⁻→2CO₃²⁻ (24)

The produced carbonate ion is supplied to the fuel electrode 242 through electrolyte 241.

Next, a configuration of the reaction device 210 will be explained. Incidentally, as for same configurations as the second embodiment, explanations are omitted by adding same reference numbers to last two digits.

As shown in FIG. 16, the reaction device 210 is composed of a reaction device body 211 and the heat insulating container 220 to house the reaction device body 211. Incidentally, as for same configurations as the second embodiment, explanations are omitted by adding same reference numbers to last two digits.

The reaction device body 211 is composed of a high temperature reaction section 217, a middle temperature reaction section 215, a low temperature reaction section 213, and a first connecting section 212, a second connecting section 214, and third connecting section 216.

The high temperature reaction section 217 includes the fuel cell stuck 240 wherein the fuel cells 240A, 240B, 240C, 240D are laminated and a catalyst combusting flow path 209a to be the catalyst combustor 209.

The oxygen electrode separator of the fuel cell 240A and the fuel electrode separator of the fuel cell 240B, the oxygen electrode separator of the fuel cell 240B and the fuel electrode separator of the fuel cell 240C, and the oxygen electrode separator of the fuel cell 240C and the fuel electrode separator of the fuel cell 240D are respectively integrated to form both-sides separators 248. The anode output electrode 246 is connected to the fuel electrode separator 244 of the fuel cell 240A, and the cathode output electrode 247 is connected to the oxygen electrode separator 245 of the fuel cell 240D. The anode output electrode 246 and the cathode output electrode 247 penetrate through the heat insulating container 220, and output the electric power produced in the fuel cell stuck 240 to the exterior.

Moreover, the high temperature reaction section 217 is provided with an electric heater/temperature sensor 257, and is maintained at about 600-700° C. by the electric heater/temperature sensor 257. The electric heater/temperature sensor 257 is connected to the lead wire 257c penetrating the heat insulating container 220 so that the electric power is supplied to the electric heater/temperature sensor 257 from outside of the heat insulating container 220 through the lead wire 257c. The electric heater/temperature sensor 257 is insulated from other members by an insulating film 257a.

The middle temperature reaction section 215 is provided with a reforming flow path 205a to be the reformer and a heat exchanging flow path 208a to be the second heat exchanger 208.

Moreover, the middle temperature reaction section 215 includes an electric heater/temperature sensor 255, and is maintained at about 300-400° C. by the electric heater/temperature sensor 255. The electric heater/temperature sensor 255 is connected to the lead wire 255c penetrating the heat insulating container 220, and the electric power is supplied to the electric heater/temperature sensor 255 from outside of the heat insulating container 220 through the lead wire 255c. The electric heater/temperature sensor 255 is insulated from other members by insulating films 255a, 255b.

The low temperature reaction section 213 is provided with a vaporizing flow path 204a to be the vaporizer 204, a carbon monoxide removing flow path 206a to be the carbon monoxide remover 206, and a heat exchanging flow path 207a to be the heat exchanger 207. Moreover, the low temperature reaction section 213 includes an electric heater/temperature sensor 253, and is maintained at about 110-160° C. by the electric heater/temperature sensor 253. The electric heater/temperature sensor 253 is connected to the lead wire 253c penetrating the heat insulating container 220 so that the electric power is supplied to the electric heater/temperature sensor 253 from outside of the heat insulating container 220 through the lead wire 253c. The electric heater/temperature sensor 253 is insulated from other members by insulating films 253a, 253b.

The first connecting section 212 includes a pipe to be a flow path through which the reactant to react in the high temperature reaction section 217, the middle temperature reaction section 215, and the low temperature reaction section 213 and the product flow. The first connecting section 212 is connected to the low temperature reaction section 213 at one end, penetrates the heat insulating container 220 on the other end side, and is connected to the liquid feeding pump 203, a not-shown air pump and the like at the other end. The first connecting section 212 includes a first pipe (outflow pipe) 212b to be a flow path through which the reactant and the product are sent from the low temperature reaction section 213 to outside of the heat insulating container 220, and a second pipe (inflow pipe) 212c through which the reactant and the product is sent from outside of the heat insulating container 220 to the low temperature reaction section 213. Similar to the second embodiment, the heat exchange may be performed between the first pipe and the second pipe.

The second connecting section 214 includes a pipe to be a flow path through which the reactant to react in the high temperature reaction section 217, the middle temperature reaction section 215 and the low temperature reaction section 213 and the produced product flow, and connects the middle temperature reaction section 215 and the low temperature reaction section 213. The second connecting section 214 is connected to the middle temperature reaction section 215 at one end and connected to the low temperature reaction section 213 at the other end. The second connecting section 214 further includes a third pipe (outflow pipe) 214b to be a flow path through which the reactant and the product are sent from the middle temperature reaction section 215 to the low temperature reaction section 213, and a fourth pipe (inflow pipe) 214c through which the reactant and the product are sent from the low temperature reaction section 213 to the middle reaction section 215. Similar to the second embodiment, the heat exchange may be performed between the third pipe and the fourth pipe.

The third connecting section 216 includes a pipe to be a flow path through which the reactant to react in the high temperature reaction section 217, the middle temperature reaction section 215 and the low temperature reaction section 213 and the produced product flow, and connects the high temperature reaction section 217 and the middle temperature reaction section 215. The third connecting section 216 is connected to the high temperature reaction section 217 at one end and connected to the middle temperature reaction section 215 at the other end. The third connecting section 216 further includes a fifth pipe (outflow pipe) 216b to be a flow path through which the reactant and the product is sent from the high temperature reaction section 217 to the middle temperature reaction section 215, and a sixth pipe (inflow pipe) 216c to be a flow path through which the reactant and the product are sent from the middle temperature reaction section 215 to the high temperature reaction section 217. Similar to the second embodiment, the heat exchange may be performed between the fifth pipe and the sixth pipe.

In the embodiment, as shown in FIG. 16, the radiation discharging film 217a is provided at the high temperature reaction section 217, and the radiation transmitting window 227 is provided at a portion facing the radiation discharging film 217a in the heat insulating container 220. Since the radiation from the radiation discharging film 217a transmits through the radiation transmitting window 227, a part of heat quantity produced in the high temperature reaction section 217 is discharged to outside of the heat insulating container 220 by the radiation. Therefore, the heat quantity conducted from the high temperature reaction section 217 to the middle temperature reaction section 215 through the third connecting section 216 can be suppressed, and the temperature of the high temperature reaction section 217 can be prevented from rising more than necessary due to the heat quantity produced in the high temperature reaction section 217 to be maintained at a proper temperature.

Moreover, according to the embodiment, the catalyst combustor 209 is located adjacent to the airtight container 250 or contacts with or is adjoined to the airtight container 250, thereby the heat produced in the fuel cell stuck 240 and the catalyst combustor 209 is likely to conduct to the airtight container 250. Moreover, the radiation discharging film 217a is provided at the portion corresponding to the catalyst combustor 209 in the airtight container 250. According to the configuration, the heat produced in the fuel cell stuck 240 and the catalyst combustor 209 is likely to conduct especially to the radiation discharging film 217a of the airtight container 250, and consequently the heat quantity to be discharged by the radiation from the fuel cell stuck 240 and the catalyst combustor 209 to outside of the heat insulating container 220 can be increased.

With respect to the configuration according to the embodiment, an advantage when the temperature of the low temperature reaction section 213 is 150° C., the temperature of the middle reaction section 215 is 400° C., the temperature of the high temperature reaction section 217 is 650° C., an efficiency of the fuel cell stuck 240 is 50%, and electricity generated is 20 W will be calculated.

Heat budgets (sum of reaction heat of each of the chemical reactions and heat exchange of the reaction gas) of the high temperature reaction section 217, the middle temperature reaction section 215, and the low temperature reaction section 213 except the heat transmission by the second connecting section 214 or the first connecting section 212 are respectively +21 W, +0.5 W and −2.5 W. When the radiation discharging film 217a is not provided, the total heat quantity of 19 W is conducted to the heat insulating container 220. For example, the heat quantity conducted from the first connecting section 212 can be suppressed to 2 W by discharging 17.5 W by the radiation discharging film 217a through the radiation transmitting window 227. When the emissivity of the radiation discharging film 217a is one (1) and the radiation transmitting window 123 is formed by BaF₂, by making a surface area of the radiation discharging film 217a be about 4.25 cm², 7.5 W may be discharged.

Incidentally, for example, when the temperature of the high temperature reaction section 217 including the molten carbonate fuel cell stuck 240 is set to about 600° C., it is preferable that the radiation of the wavelength within 1.4-11 μm transmits through. In this case, any of the above-described materials may be used as the material of the radiation discharging window 227, and especially CaF₂, BaF₂, ZnSe, KRS-5, KRS-6, CsI, KBr, AlF₃, NaCl, KF, KCl, CsCl, CsBr, CsF, NaBr, KI, NaI, AgCl, AgBr, TlBr, BiF₃, CdSe, CdS, CdTe, CeF₃, CeO₂, DyF₂, GaAs, GaSe, Gd₂O₃, HfO₂, LaO₃, NaF, PbF₂, Si, TlCl, YF₃, ZnO, ZnS are preferably used in view of the transmittance in the wavelength. Moreover, for example, when the heat is discharged also from the middle temperature reaction section 215 including the reformer 205 of 400° C., it is preferable that the radiation of the wavelength within 2.2-17 μm transmits through. In this case, any of the above-described materials may be used as the material of the radiation transmitting window 225, and especially ZnSe, KRS-5, KRS-6, CsI, KBr, NaCl, KCl, CsCl, CsBr, CsF, NaBr, KI, NaI, AgCl, AgBr, TlBr, BiF₃, CdSe, CdS, CdTe, GaAs, GaSe, Ge, NaF, PbF₂, TlCl, YF₃, ZnO are preferably used in view of the transmittance in the wavelength.

As described above, in the embodiment, the materials used for the radiation discharging film 217a and the radiation transmitting window 227 may be changed appropriately depending on the heat discharge amount and the temperature of the radiation discharging region. Moreover, the areas of the radiation discharging film 217a and the radiation transmitting window 227 may be changed appropriately depending on the heat discharge amount, and conversely, when installation areas thereof are restricted, the materials of the radiation discharging film 217a and the radiation transmitting window 227 may be changed depending on the restriction. In addition, the above calculated values are values when the heat exchange is not performed between the first pipe and the second pipe, between the third pipe and the fourth pipe, or between the fourth pipe and the fifth pipe, and the case where the emissivity is one (1) means the case where the emissivity obtained by integration in whole wavelength region is one (1). Moreover, though the above-described wavelength region preferable to transmit through is a wavelength region where the normalized radiation intensity becomes 0.1 or more, the wavelength may be changed appropriately, and additionally, the material of the radiation transmitting window corresponding to the changed wavelength region may be selected.

### Fourth Embodiment

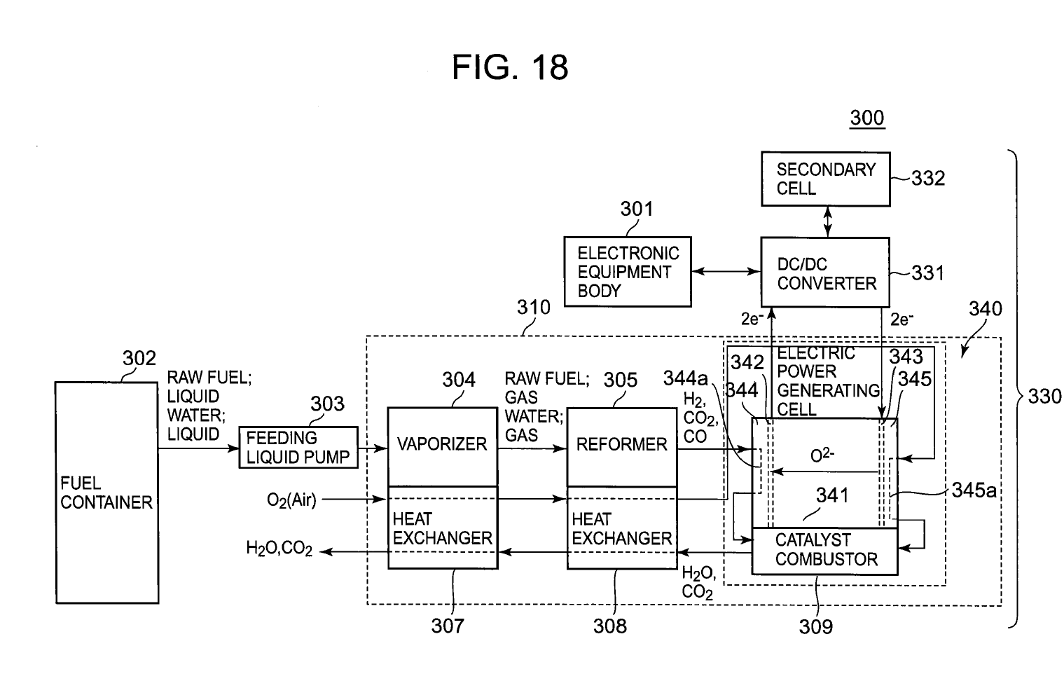

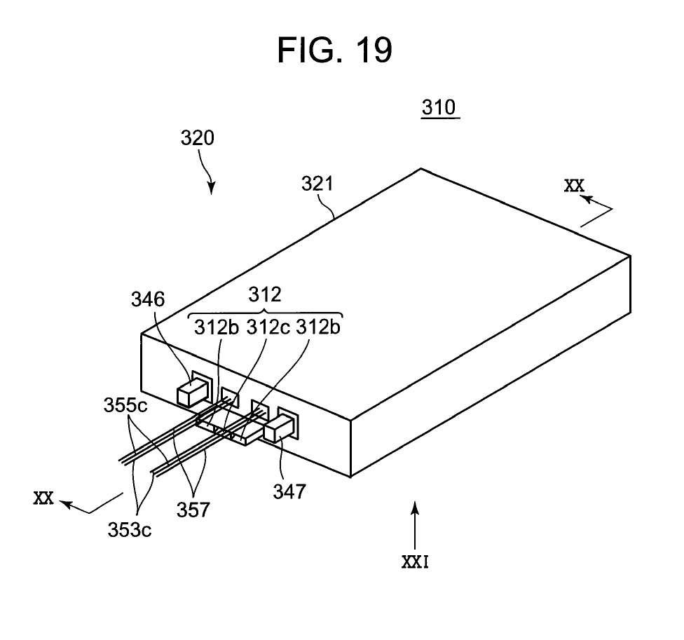

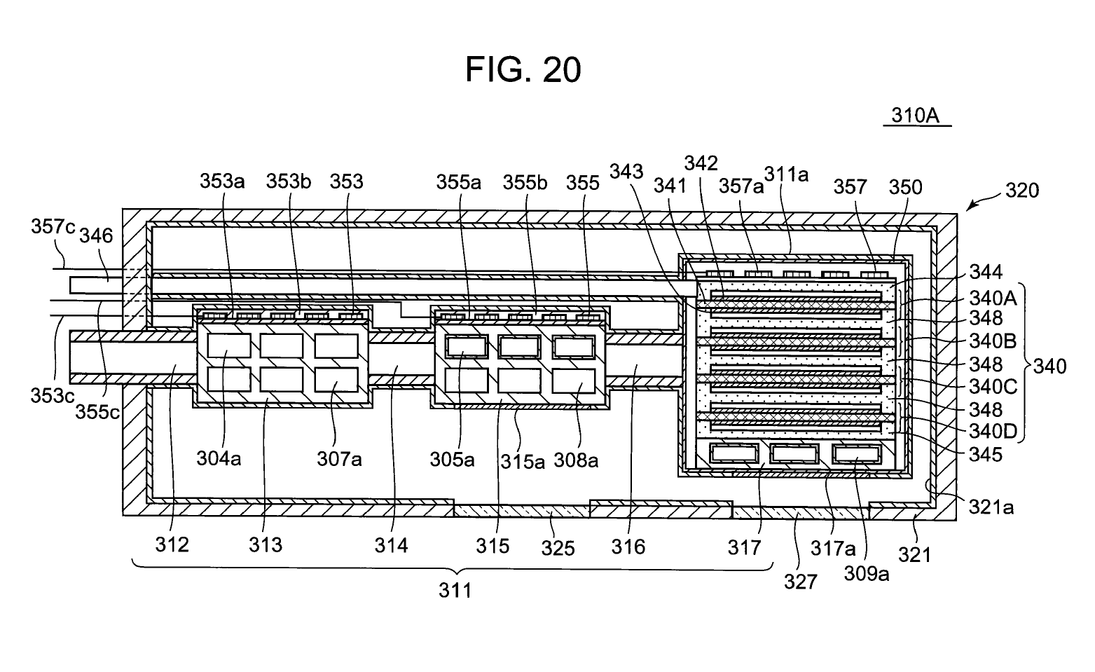

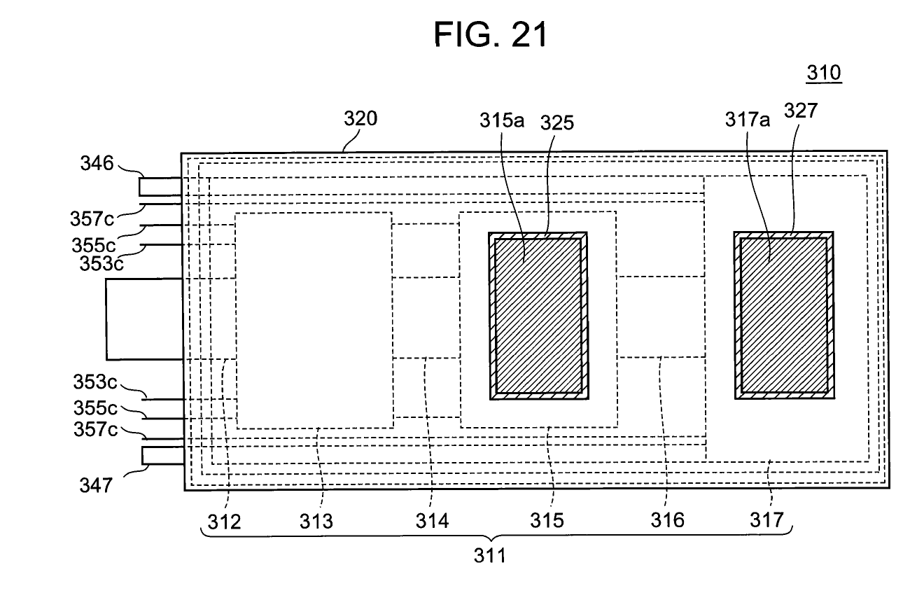

Next, a forth embodiment of the present invention will be explained. FIG. 18 is a block diagram showing electronic equipment 300 according to the fourth embodiment of the present invention, FIG. 19 is a perspective diagram of a reaction device 310, FIG. 20 is a schematic cross-section diagram corresponding to a cutting-plane line XX-XX in FIG. 19, and FIG. 21 is a view on arrow XVII of FIG. 19. Hereinafter, differences between the embodiment and the third embodiment will be explained, and as for same configurations as the third embodiment, explanations are omitted by adding same reference numbers to last two digits.

A fuel cell stuck 340 is a solid oxide fuel cell, and is configured by laminating a plurality of fuel cells 340A, 340B, 340C, 340D. Similar to the third embodiment, a carbon monoxide remover is not used in the reaction device 310. The integrated fuel cell stuck 340 and the catalyst combustor 309 is housed in an airtight container 350, and the airtight container (second container) 350 is housed in the heat insulating container (first container) 320. The airtight container 350 is a container for preventing the gas from flowing in and out of a space separated by the airtight container 350, and portions through which the anode output electrode 346 and the cathode output electrode 347, and the lead wire 357c and the third connecting section 316 penetrate are air-tightened. Incidentally, each of the output electrodes and the lead wires is insulated from other members by not-shown insulating material such as glass and ceramic to be pulled out.

Incidentally, in FIG. 18, only single fuel cell 340A among a plurality of fuel cells 340A, 340B, 340C, 340D is shown, and alphabets in last digit of the reference numbers are omitted.

Reactions occur in the single fuel cell 340 and the catalyst combustor 309 will be explained below.

The fuel cell 340 is configured by laminating an electrolyte 341, a fuel electrode 342 (anode) and a oxygen electrode 343 (cathode) formed on both sides of the electrolyte 341, a fuel electrode separator 344 provided with a fuel feeding flow path 344a for supplying the reformed gas to the fuel electrode 342, and an oxygen separator 345 provided with an oxygen feeding flow path 345a for supplying the oxygen to the oxygen electrode 343.

The electrolyte 341 has a property of being transmitted through by oxygen ion and not being transmitted through by oxygen molecule, hydrogen molecule, carbon monoxide, carbon dioxide, or electron.

The reformed gas is sent to the fuel electrode 342 through the fuel feeding flow path 344a. In the fuel electrode 342, reactions shown in the following electrochemical reaction formulas (25), (26) by the hydrogen in the reformed gas, carbon monoxide and the oxygen ion which has transmitted through the electrolyte 341 occur.

H₂+O²⁻→H₂O+2e⁻ (25)

CO+O²⁻→CO₂+2e⁻ (26)

The produced electron is supplied to the anode output electrode 346. The unreacted reformed gas (off gas) is supplied to the catalyst combustor 309.

The oxygen (air) heated by the first heat exchanger 307 and the second heat exchanger 308 is supplied to the oxygen electrode 343 through the oxygen feeding flow path 345a. In the oxygen electrode 343, a reaction shown in the following electrochemical reaction formula (27) occurs by the oxygen and the electron supplied from the cathode output electrode 347.

½O₂+2e⁻→O²⁻ (27)

The produced oxygen ion is supplied to the fuel electrode 342 through the electrolyte 341. The unreacted oxygen (air) is supplied to the catalyst combustor 309.

In the catalyst combustor 309, the off gas which has passed through the fuel feeding flow path 344a and the oxygen (air) which has passed through the oxygen feeding flow path 345a is mixed, and the hydrogen in the off gas and the carbon monoxide are combusted. The combustion heat is used for heating the fuel cell stuck 340.

The exhaust gas (mixed gas of the water, the oxygen and the carbon dioxide) discharges the heat in the second heat exchanger 308 and the first heat exchanger 307 to be ejected.

In the embodiment, the high temperature reaction section 317 where the fuel cell stuck 340 and the catalyst combustor 309 are integrally provided is maintained about 700-1000° C. by the electric heater/temperature sensor 357 and the catalyst combustor 309.

As shown in FIG. 20, in the reaction device 310, the radiation discharging film 317a is provided in the high temperature reaction section 317, and the radiation transmitting window 327 is provided at the portion facing the radiation discharging film 317a in the heat insulating container 320. Since the radiation from the radiation discharging film 317a transmits through the radiation transmitting window 327, a part of the heat quantity produced in the high temperature reaction section 317 is discharged to outside of the heat insulating container 320 by the radiation. Therefore, the heat quantity conducted from the high temperature reaction section 317 to the middle temperature reaction section 315 through the third connecting section 316 can be reduced, and the temperature of the high temperature reaction section 317 can be prevented from rising more than necessary due to the heat quantity produced in the high temperature reaction section 317 to be maintained at proper temperature.

Moreover, in the embodiment, as shown in FIG. 20, the radiation discharging film 315a is provided in the middle temperature reaction section 315, and the radiation transmitting window 325 is provided at the portion facing the radiation discharging film 315a in the heat insulating container 320. Since the radiation from the radiation discharging film 315a transmits through the radiation transmitting window 325, a part of the heat quantity produced in the middle temperature reaction section 315 is discharged to outside of the heat insulating container 320 by the radiation. Therefore, the heat quantity conducted from the middle temperature reaction section 315 to the low temperature reaction section 313 through the second connecting section 314 can be suppressed, and the temperature of the middle temperature reaction section 315 can be prevented from rising more than necessary due to the heat quantity transmitted from the third connecting section 316 to be maintained at proper temperature.

Furthermore, also in the embodiment, the catalyst combustor 309 is located adjacent to the airtight container 350 or contacts with or is adjoined to the airtight container 350, thereby the heat produced in the fuel cell stuck 340 and the catalyst combustor 309 is likely to conduct to the airtight container 350. Moreover, the radiation discharging film 317a is provided at the portion corresponding to the catalyst combustor 309 in the airtight container 350. According to the configuration, the heat produced in the fuel cell stuck 340 and the catalyst combustor 309 is likely to conduct especially to the radiation discharging film 317a of the airtight container 350, and consequently the heat quantity to be discharged by the radiation from the fuel cell stuck 340 and the catalyst combustor 309 to outside of the heat insulating container 320 can be increased.

Incidentally, when the fuel cell device 330 is started up, the temperature of the high temperature reaction section 317 is risen up to an operation temperature of the solid oxide fuel cell such as about 700-1000° C. by the heater/temperature sensor 357. In the embodiment, since the radiation is discharged on the surface of the high temperature reaction section 317 at the side opposite to the side where the heater/temperature sensor 357 is provided, the surface of the high temperature reaction section 317 at the side being heated is resistant to being cooled so that the high temperature reaction section 317 may be heated efficiently.

In the configuration according to the embodiment, an advantage when the temperature of the low temperature reaction section 313 is 150° C., the temperature of the middle temperature reaction section 315 is 400° C., the temperature of the high temperature reaction section 317 is 800° C., an efficiency of the fuel cell 340 is 60% and electricity generated is 20 W will be calculated.

Heat budgets (sum of reaction heat of each of the chemical reactions and heat exchange of the reaction gas) of the high temperature reaction section 317, the middle temperature reaction section 315 and the low temperature reaction section 313 except heat transmission by the third connecting section 316, the second connecting section 314 or the first connecting section 312 are +10 W, +3 W and +0 W respectively. When the radiation discharging films 312a, 316a are not provided, the total quantity of 13 W conducts to the heat insulating container 320. For example, by discharging 8 W, 3 W by the radiation discharging films 315a, 317a through the radiation transmitting windows 325, 327, the heat quantity conducted from the first connecting section 312 can be suppressed to 2 W. When the emissivity of the radiation discharging films 315a, 317a is one (1) and the radiation transmitting window 123 is formed by BaF₂, 8 W and 3 W can be discharged by making surface areas of the radiation discharging films 315a, 317a be about 1.3 cm², 2.6 cm² respectively.

Incidentally, the temperature of the high temperature reaction section 317 having the solid oxide fuel cell stuck 340 is about 800° C., and it is preferable that the radiation of the wavelength within 1.1-9 μm transmits through. In this case, any of the above-described materials may be used as the material of the radiation transmitting window 327, and especially CaF₂, BaF₂, ZnSe, MgF₂, KRS-5, KRS-6, CsI, KBr, AlF₃, NaCl, KF, KCl, CsCl, CsBr, CsF, NaBr, KI, NaI, AgCl, AgBr, TlBr, BiF₃, CdSe, CdS, CdTe, CeF₃, CeO₂, DyF₂, GaAs, GaSe, Gd₂O₃, HfO₂, La₂O₃, MgO, NaF, PbF₂, Si, Si₃N₄, SrF₂, TlCl, YF₃, Y₂O₃, ZnO, ZnS may be preferably used in view of transmittance in the wavelength region. Moreover, for example, when the heat is discharged also from the middle temperature reaction section 315 having the reformer 305 of about 400° C., it is preferable that the radiation of wavelength within 2.2-17 μm transmits through. In this case, any of the above-described materials may be used as the material of the radiation transmitting window 325, and especially ZnSe, KRS-5, KRS-6, CsI, KBr, NaCl, KCl, CsCl, CsBr, CsF, NaBr, KI, NaI, AgCl, AgBr, TlBr, BiF₃, CdSe, CdS, CdTe, GaAs, GaSe, Ge, NaF, PbF₂, TlCl, YF₃, ZnO may be preferably used in view of transmittance in the wavelength region.

As described above, according to the embodiment, the materials of the radiation discharging films 315a, 317a and the radiation transmitting window 325, 327 may be selected appropriately depending on the heat radiation amount or the temperature of the radiation transmitting region. Moreover, the areas of the radiation discharging films 315a, 317a and the radiation transmitting window 325, 327 may be changed appropriately depending on the heat radiation amount, and conversely, when installation areas thereof are restricted, the materials of the radiation discharging films 315a, 317a and the radiation transmitting windows 325, 327 may be changed depending on the restriction. In addition, the above calculated values are values when the heat exchange is not performed between the first pipe and the second pipe, between the third pipe and the fourth pipe, or between the fifth pipe and the sixth pipe, and the case where the emissivity is one (1) means the case where the emissivity obtained by integration in whole wavelength region is one (1). Moreover, though the above-described wavelength region preferable to transmits through is a wavelength region where the normalized radiation intensity becomes 0.1 or more, the wavelength may be changed appropriately, and additionally, the material of the radiation transmitting window corresponding to the changed wavelength region may be selected.

Incidentally, though the radiation discharging films 315a, 317a are provided in both of the middle temperature reaction section 315 and the high temperature reaction section 317, the radiation discharging film may be provided in only one of the reaction sections. In this case, only one of the radiation transmitting windows 325, 327 may be provided so as to face the provided radiation discharging film.

### <Variation 4>

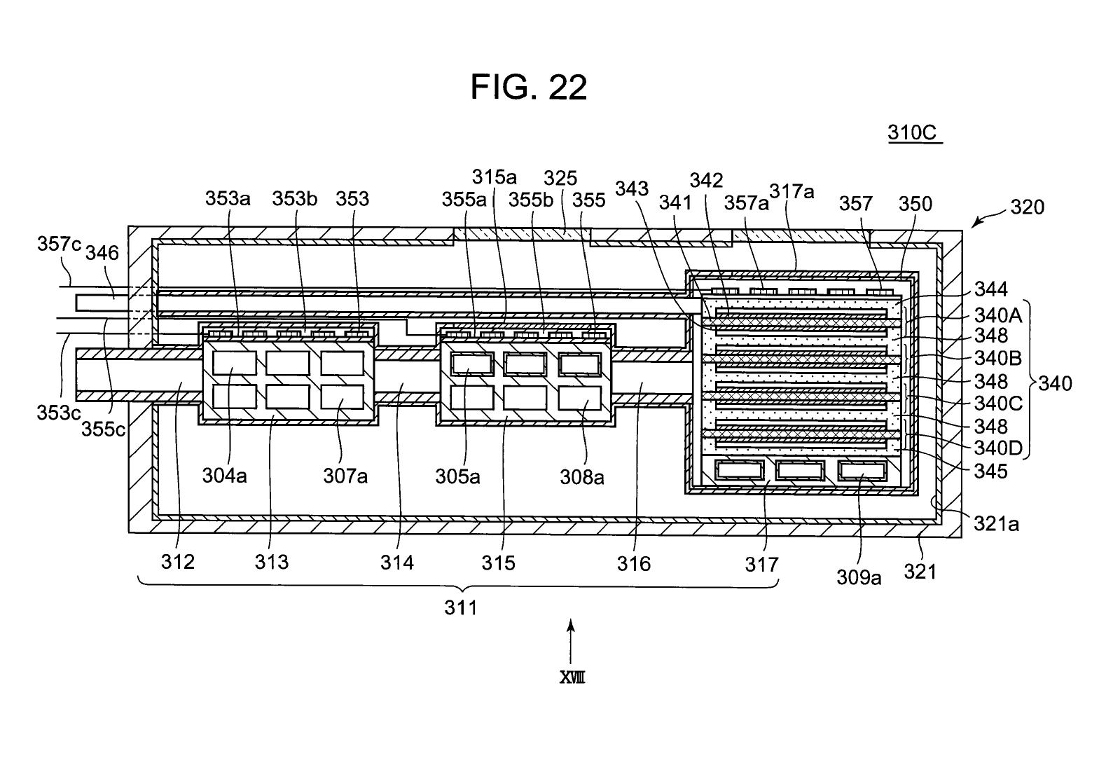

FIG. 22 is a schematic cross-section diagram similar to FIG. 20, the diagram showing a configuration of a reaction device 310A according to a fourth variation of the present invention. As for same configuration as the forth embodiment, the explanation thereof is omitted by adding the same reference numbers. In the variation, the radiation discharging films 315a, 317a are provided on upper surfaces of the middle temperature reaction section 315 and the high temperature reaction section 317 respectively, and the radiation transmitting windows 325, 327 are provided on portions facing the radiation discharging films 315a, 317a in the heat insulating container 220. Therefore, in the variation, the heat is discharged on surfaces of the middle temperature reaction section 315 and the high temperature reaction section 317 on which the heater/temperature sensors 355, 377 are provided respectively.

When heat value in the high temperature reaction section 317 is larger than heat value in the catalyst combustor 309a, the temperature of the side of the high temperature reaction section 317, on which the catalyst combustor 309a is provided, becomes relatively low. Therefore, like the variation, by discharging the heat on the surface of the high temperature reaction section 317 on the side opposite to the side where the catalyst combustor 309a is provided, a temperature distribution in the high temperature reaction section 317 can be uniform.

### <Variation 5>

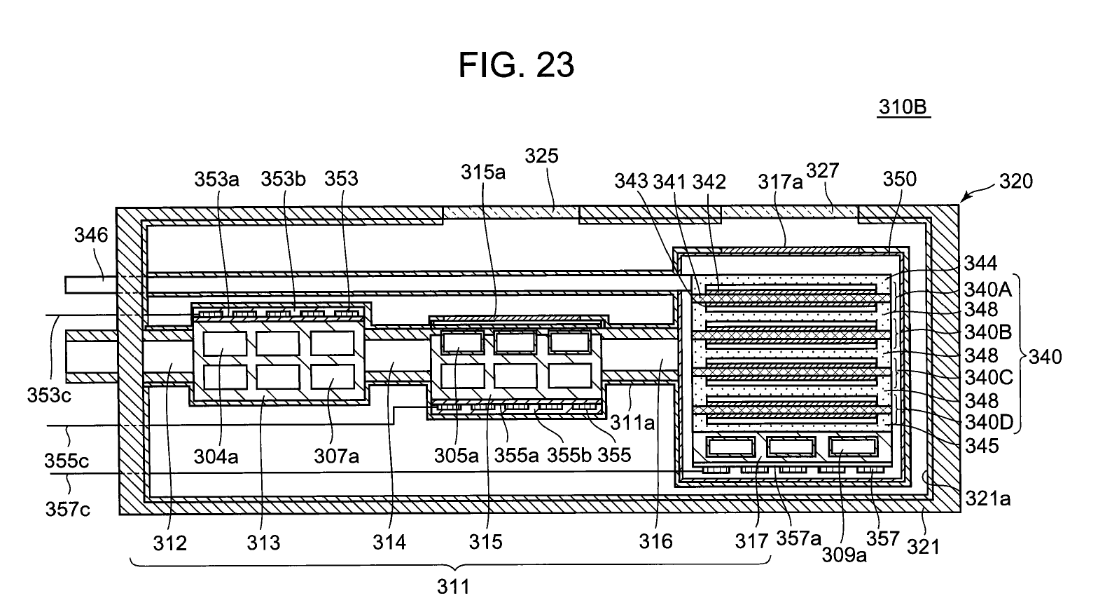

FIG. 23 is a schematic cross-section diagram similar to FIG. 20, the diagram showing a configuration of a reaction device 310B according to a fifth variation of the present invention. As for same configuration as the forth embodiment, the explanation thereof is omitted by adding the same reference numbers. In the variation, heater/temperature sensors 355, 357 are provided on lower surfaces of the middle temperature reaction section 315 and the high temperature reaction section 317, the radiation discharging films 315a, 317a are provided on upper surfaces of the middle temperature reaction section 315 and the high temperature reaction section 317, and the radiation transmitting windows 325, 327 are provided at portions facing the radiation discharging films 315a, 317a in the heat insulating container 320. Therefore, in the variation, the radiation is discharged respectively on the surfaces of the middle temperature reaction section 315 and the high temperature reaction section 317 on the side opposite to the side where the heater/temperature sensors 355, 357 are provided.

Incidentally, the fuel cell device 330 may be started up by the following proceeding. Specifically, the temperature of the middle temperature reaction sensor 315 is risen up to the temperature capable of producing the reformed gas, for example about 300-400° C., by the heater/temperature sensor 355, and the temperature of the high temperature reaction section 317 is risen up to the operation temperature of the solid oxide fuel cell such as about 700-1000° C., by combusting the hydrogen in the catalyst combustor 309a.

In the variation, since the heater/temperature sensor 357 is provided in the vicinity of the catalyst combustor 309a and the radiation is discharged on the surface of the high temperature reaction section 317 on the side opposite to the side being heated, the heater/temperature sensor 357 can efficiently conduct the heat to the catalyst combustor 309a, and the surface of the high temperature reaction section 317 on the side to be heated is resistant to be cooled so that the high temperature reaction section 317 can be heated efficiently. Incidentally, also in the variation, the fuel electrode separator 344 may be located adjacent to the airtight container 350 or contacts with the airtight container 350 through the insulating film. In this case, similar to above-described embodiments, the heat produced in the fuel cell stuck 340 is likely to conduct to the airtight container 350, thereby the heat quantity discharged by the radiation from the fuel cell stuck 340 to outside of the heat insulating container 320 can be increased.

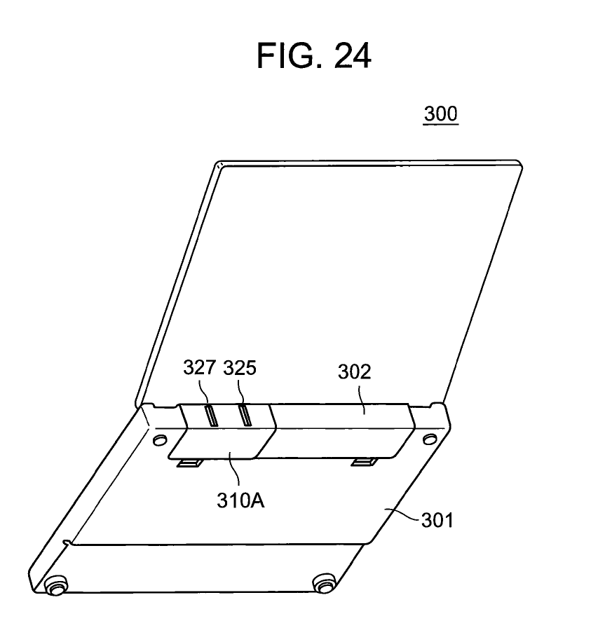

FIG. 24 is a perspective diagram showing a configuration example of the electronic equipment 300 according the embodiment. Incidentally, the electronic equipment 300 shown in FIG. 24 is a note-book sized personal computer. As shown in FIG. 24, the reaction device 310 is attached to a back side of the electronic equipment 300, and the radiation transmitting windows 325, 327 are provided along an outer circumference surface of the electronic equipment 300. Thus, the radiations discharged from the radiation discharging films 315a, 317a transmits through the radiation transmitting windows 325, 327 to be discharged to the exterior, thereby the heat transmission to the electronic equipment body 301 may be suppressed so as to prevent the temperature rise. In this case, since it is enough to prevent the heat transmission to the electronic equipment body 301, the radiation transmitting windows 325, 327 need not always be located on outermost surfaces, and may be located at a recessed parts recessed from the outermost surfaces or a projected parts projected from the outermost surfaces. Furthermore, since the radiation transmitting windows 325, 327 are provided on back side, the radiation can be prevented from discharging to a user using the electronic equipment 300.

### Fifth Embodiment

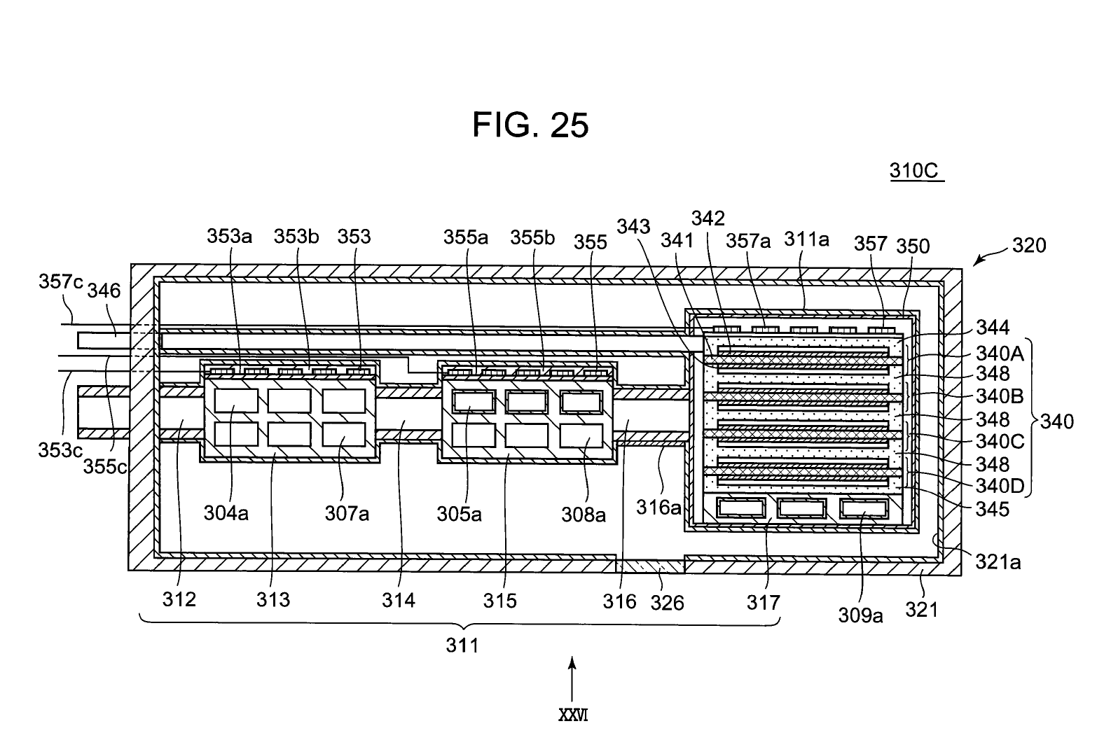

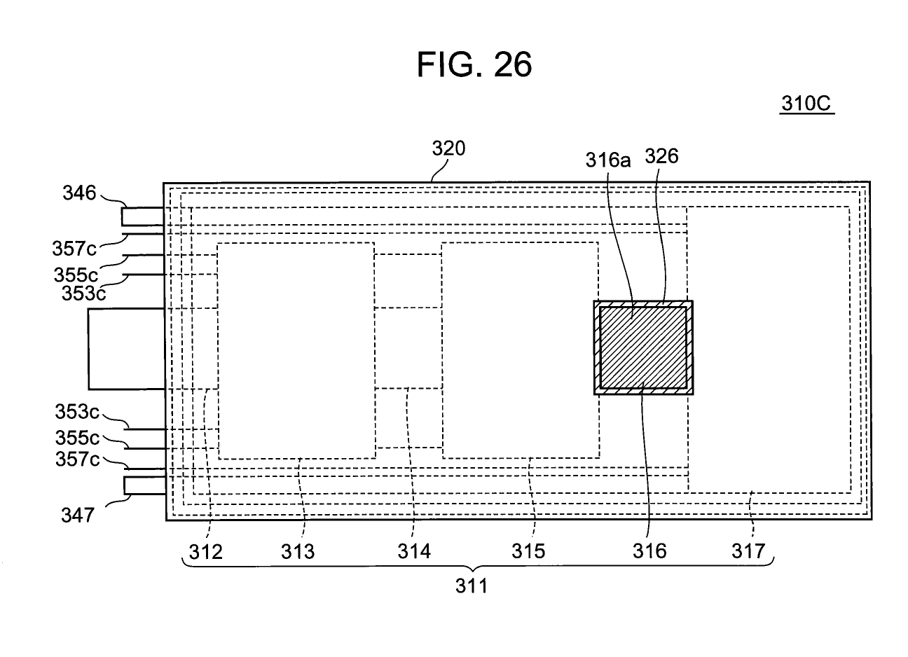

Next, a fifth embodiment of the present invention will be described. FIG. 25 is a schematic cross-section diagram of the reaction device 310C according to a fifth embodiment of the present invention, similar to FIG. 20, and FIG. 26 is a view on arrow XXVI of FIG. 25, similar to FIG. 21. A perspective diagram is omitted because it is same as FIG. 20. Incidentally, as for same configuration as the forth embodiment, the explanation thereof is omitted by adding the same reference numbers.

As shown in FIGS. 25, 26, the radiation discharging film 316a may be provided in the third connecting section 316, and the radiation transmitting window 326 may be provided at a portion facing the radiation discharging film 316a in the heat insulating container 320. Since a part of the heat quantity conducted from the high temperature reaction section 317 to the third connecting section 316 is radiated from the radiation discharging film 316a and discharged from the radiation transmitting window 326 to outside of the heat insulating container 320, the temperature of the middle temperature reaction section 315 can be maintained at a proper temperature while suppressing the heat transmission quantity from the high temperature reaction section 317 to the heat insulating container 320 through the middle temperature reaction section 315.

As a specific example, a length of the third connecting section 316 in the case where there is the heat transmission of 5 W from the high temperature reaction section 317 to the third connecting section connected to the middle temperature reaction section 315, the temperature thereof is 800° C., and the temperature of the middle temperature reaction section 315 is maintained at 400° C. while suppressing the heat transmission quantity (Q_{S1}) conducted from the third connecting section 316 to the middle temperature reaction section 315 to 2 W will be explained below. Incidentally, when the radiation discharging film 316a is provided in the third connecting section 316, the heat transmission quantity (Q_{S1}) by the radiation discharging film 316a is 3 W and the following formula (28) is satisfied.

Q_{S1}=Q_{RA}−Q_{Sr} (28)

As an example and a comparative example, a pipe length necessary for the third connecting section 316 are calculated with respect to each of the following examples.

### FIRST EXAMPLE

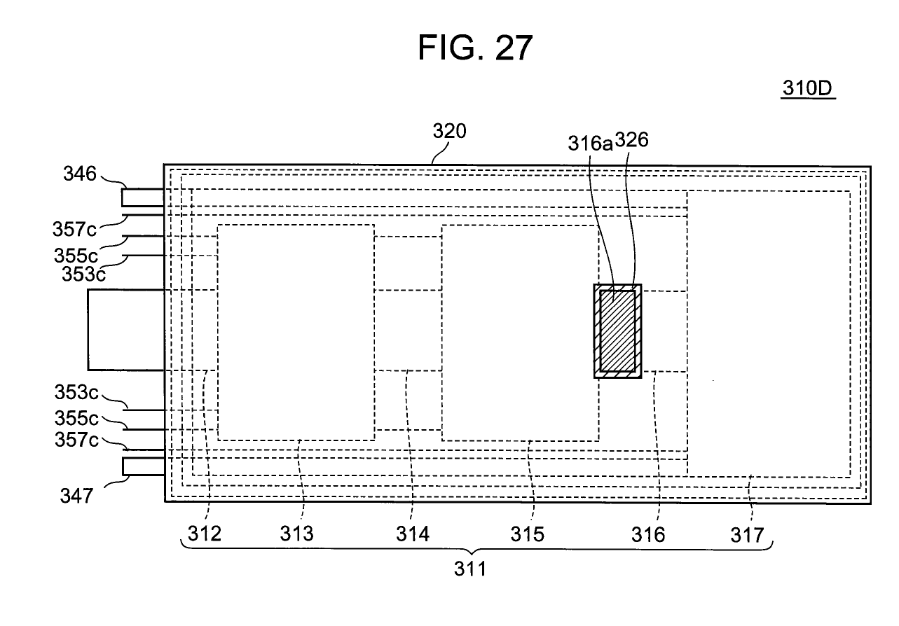

The radiation discharging film 316a and the radiation transmitting window 326 are provided in portions of the third connecting section 316, which portions are near the middle temperature reaction section 315 and have relatively low temperatures to discharge the radiation. FIG. 27 is a bottom diagram of a reaction device 310D according to a first example. A schematic cross-section diagram of the reaction device 310D is omitted because it is same as FIG. 25.

### SECOND EXAMPLE

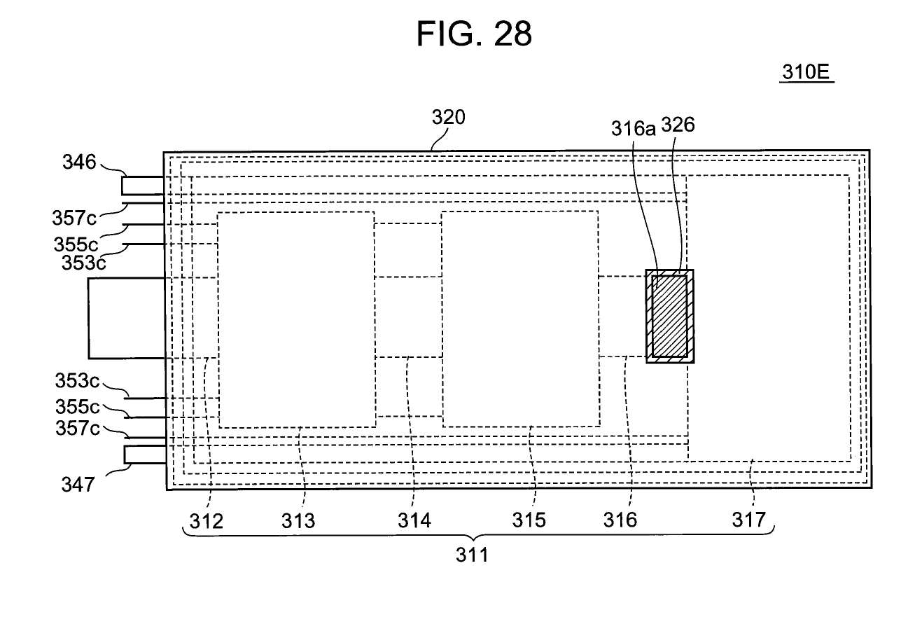

The radiation discharging film 316a and the radiation transmitting window 326 are provided in portions of the third connecting section 316, which portions are near the high temperature reaction section 317 and have relatively high temperatures to discharge the radiation. FIG. 28 is a bottom diagram of a reaction device 310E according to a second example. A schematic cross-section diagram of the reaction device 310E is omitted because it is same as FIG. 25.

### FIRST COMPARISON EXAMPLE

The radiation discharging film 317a and the radiation transmission window 327 are provided in the high temperature reaction section 317 to discharge the radiation.

### SECOND COMPARISON EXAMPLE

The radiation discharging is not performed. In other words, Q_{Sr}=0 W and the heat quantity of 5 W directly conducts to the middle temperature reaction section 315.

Incidentally, the third connecting section 316 is formed by inconel which is heat resisting material, and three square tubes whose widths are 3 mm, heights are 3 mm, and radial thicknesses are 0.25 mm are used.

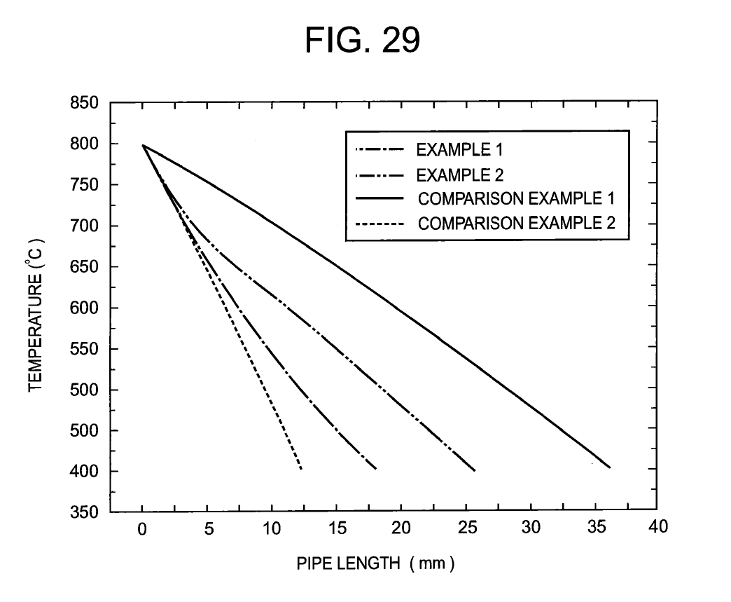

FIG. 29 is a graph showing a result of calculating relations between lengths of the third connecting sections 316 from the high temperature reaction sections 317 and a temperature in the above-described first example, the second example, the first comparative example and the second comparative example. Same results are shown in table 1.

TABLE 1

| | | Comparative | Comparative |
|---|---|---|---|
| Example 1 | Example 2 | example 1 | example 2 |
| 18.2 mm | 25.6 mm | 36.3 mm | 12.3 mm |

In the first example, by radiating the heat in a region (whose temperature range corresponds to a region of 400° C.-725° C.) of the third connecting section 316 located 15.5 mm from an end (second end) connected to the middle temperature reaction section 315, the heat discharge amount Q_{Sr} becomes 3 W and the heat transmission quantity Q_{S} to the middle temperature reaction section 315 is suppressed to 2 W.

In the second example, the heat is discharged in a region (whose temperature range corresponds to a region of 647° C.-800° C.) of the third connecting section 316 located 7.8 mm from an end (first end) connected to the high temperature reaction section 317. By radiating the heat in these regions, the above-described conditions are satisfied.

As described above, when the heat is radiated in the third connecting section 316, the length of the third connecting section 316 can be shortened in comparison with the case where the same heat quantity is radiated only in the high temperature reaction section 317, thereby the reaction device 310C can be downsized.

Moreover, according to the formula (4), the radiation energy amount of the radiation transmitting window per unit area increases in proportion to the fourth power of the temperature. Therefore, for example, when the predetermined energy amount such as 3 W is radiated, the area of the radiation transmitting window 326 can be smaller in the case where the radiation discharging film 316a is provided at the relatively high temperature portion of the reaction device body and the radiation is discharged through the radiation transmitting window 326 as the second example, in comparison the case where the radiation is discharged from the relatively low temperature region as the first example. Furthermore, it becomes easier to obtain the high radiation transmittance material of the radiation transmitting window 326, which material is efficiently transmitted by the radiation of the wavelength region corresponding to the temperature range.

On the other hand, by providing the radiation discharging film 316a and the radiation transmitting window 326 in the relatively low temperature region of the third connecting section 316 to discharge the radiation, an overall length of the third connecting section 316 can be shortened. Moreover, as described above, when the predetermined energy amount such as 3 W is radiated for example, the area of the region for radiation becomes large so that the radiation is not concentrated and dispersed. As a result, when the reaction device is mounted in the electronic equipment, safety of the electronic equipment for a user can be improved.

Incidentally, when the radiation is not discharged, the length of the third connecting section 316 can be shortest, but the heat quantity of 5 W conducts to the middle temperature reaction section 315. Thus, it is necessary to discharge the radiation in other regions.

### <Variation 6>

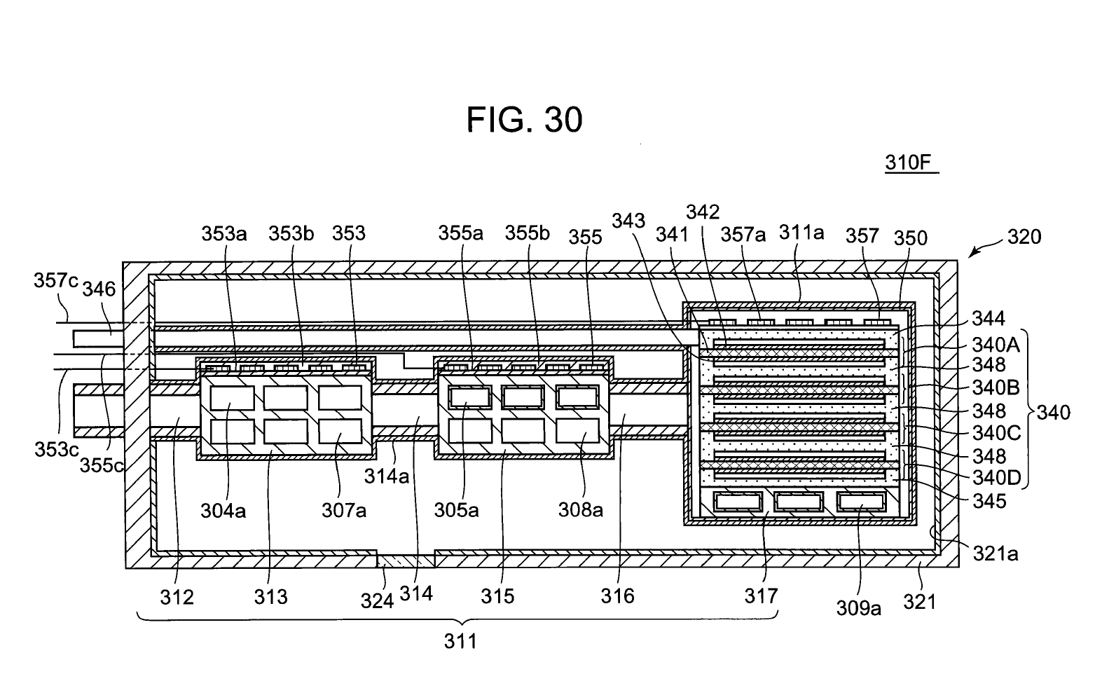

As shown in FIG. 30, the radiation discharging film 314a may be provided in the second connecting section 314, and the radiation transmitting window 324 may be provided in the portion facing the second connecting section 314 in the heat insulating container 320. Since a part of heat quantity conducted from the middle temperature reaction section 315 to the second connecting section 314 is radiated from the radiation discharging film 314a to be discharged from the radiation transmitting window 324 to outside of the heat insulating container 320, the temperature of the low temperature reaction section 313 can be maintained at a proper temperature while suppressing the heat transmission quantity from the middle temperature reaction section 315 and the high temperature reaction section 317 to the heat insulating container 320 through the low temperature reaction section 313.

Also in the variation, the length of the second connecting section 314 can be shortened when the radiation is discharged in the second connecting section 314, in comparison with the case where the radiation is discharged only in the middle temperature reaction section 315, not in the second connecting section 314. Moreover, when the radiation is discharged in the second connecting section 314, the length of the second connecting section 314 can be shortened when the radiation discharging film 314a and the radiation transmitting window 324 are provided in the relatively low temperature region in the second connecting section 314 to discharge the radiation. In both of the cases, the reaction device 310F can be more downsized. Furthermore, similar to the fifth embodiment, the area of the radiation transmitting window 324 can be smaller when the radiation discharging film 314a and the radiation transmitting window 324 are provided in the relatively high temperature region of the second connecting section 314.

### <Variation 7>

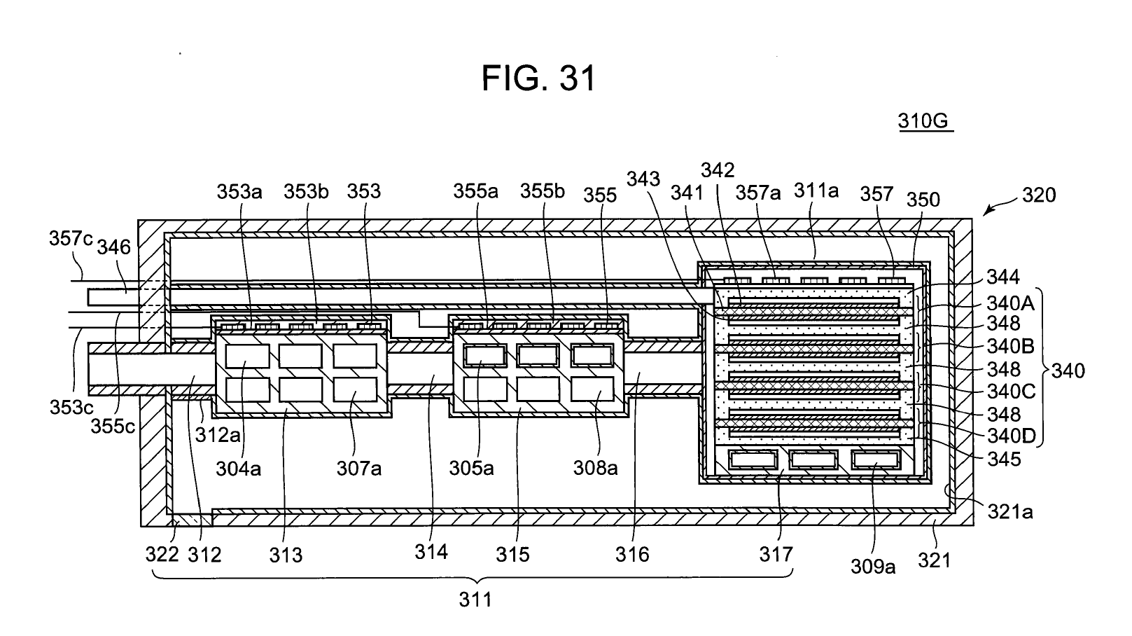

As shown in FIG. 31, the radiation discharging film 312a may be provided in the first connecting section 312, and the radiation transmitting window 322 may be provided in the portion facing the radiation discharging film 312a in the heat insulating container 320. Since a part of heat quantity conducted from the low temperature reaction section 313 to the first connecting section 312 is radiated from the radiation discharging film 312a to be discharged from the radiation transmitting window 322 to outside of the heat insulating container 320, the temperatures of the low temperature reaction section 313, the middle temperature reaction section 315 and the high temperature reaction section 317 can be maintained at proper temperatures while suppressing the heat transmission quantity from the low temperature reaction section 313, the middle temperature reaction section 315 and the high temperature reaction section 317 to the heat insulating container 320.

Also in the variation, the length of the first connecting section 312 can be shortened when the radiation is discharged in the first connecting section 312, in comparison with the case where the radiation is discharged only in the low temperature reaction section 313, not in the first connecting section 312. Moreover, when the radiation is discharged in the first connecting section 312, the length of the first connecting section 312 can be shortened when the radiation discharging film 312a and the radiation transmitting window 322 are provided in the relatively low temperature region in the first connecting section 312 to discharge the radiation. In both of the cases, the reaction device 310G can be more downsized. Furthermore, similar to the fifth embodiment and variation 6, the area of the radiation transmitting window 322 can be smaller when the radiation discharging film 312a and the radiation transmitting window 322 are provided in the relatively high temperature region of the first connecting section 312.

### Sixth Embodiment

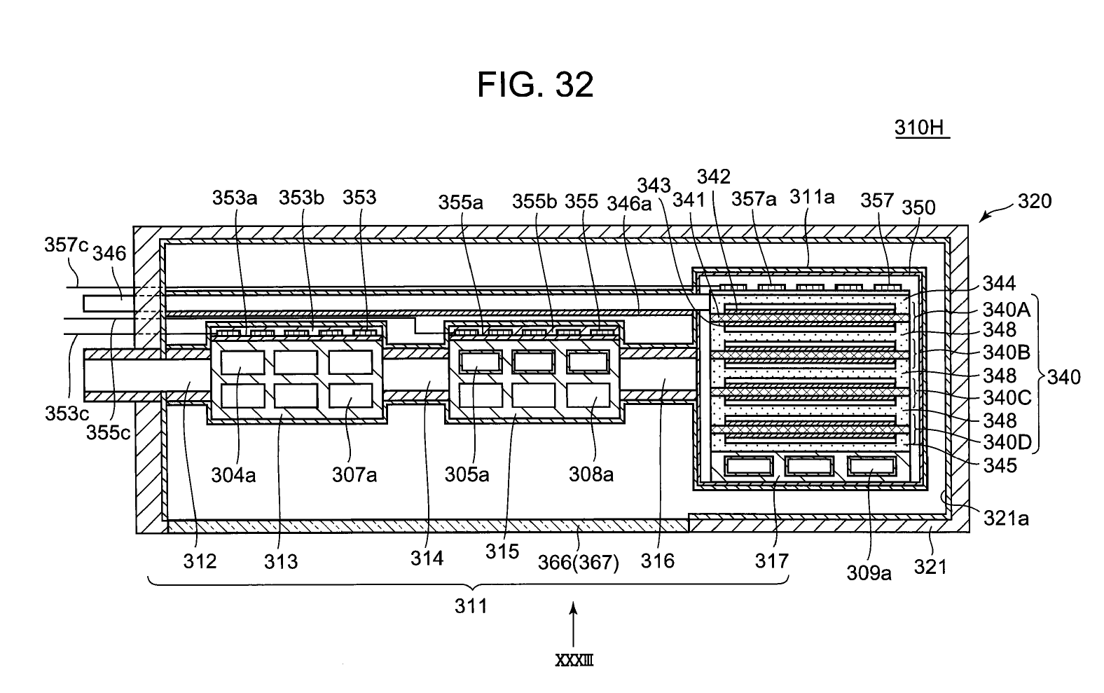

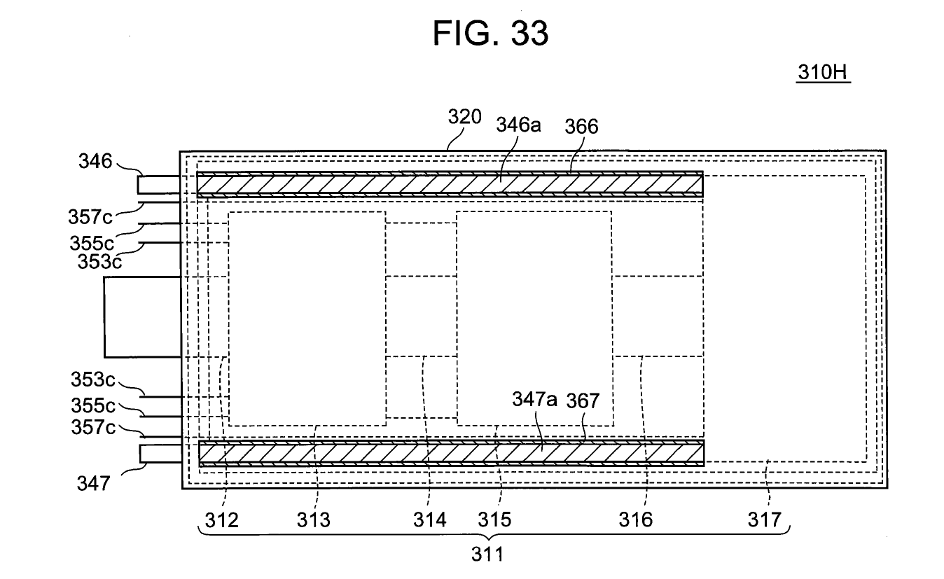

Next, a sixth embodiment will be explained. FIG. 32 is a schematic cross-section diagram similar to FIG. 20, the diagram showing a reaction device 310H according to a sixth embodiment of the present invention, and FIG. 33 is a view on arrow XXXIII of FIG. 32. A perspective diagram is omitted because it is same as FIG. 20.

As shown in FIGS. 32, 33, the radiation discharging films 346a, 347a may be provided in the anode output electrode 346 and the cathode output electrode 347, and the radiation transmitting windows 366, 367 may be provided in portions facing the radiation discharging films 346a, 347a in the heat insulating container 320.

The lengths of the anode output electrode 346 and the cathode output electrode 347 in the case where there is the heat transmission of 5 W from the high temperature reaction section 317 to the third connecting section connecting the high temperature reaction section 317 to the middle temperature reaction section 315, the temperature of high temperature reaction section 317 is 800° C., and the temperature of the heat insulating container 320 is maintained at 50° C. while suppressing the heat transmission quantity (Q_{S1}) conducted from the high temperature reaction section 317 to the heat insulating container 320 through the anode output electrode 346 and the cathode output electrode 347 to 0.5 W will be explained below as a specific example. Incidentally, when the radiation discharging films 346a, 347a are provided in the anode output electrode 346 and the cathode output electrode 347, the heat transmission quantity (Q_{S1}) by the radiation discharging films 346a, 347a is 4.5 W, and the above-described formula (28) is satisfied.

As examples and comparison examples, pipe lengths necessary for the anode output electrode 346 and the cathode output electrode 347 are calculated with respect to the following examples. In addition, the anode output electrode 346 and the cathode output electrode 347 are formed to be same shapes.

### THIRD EXAMPLE

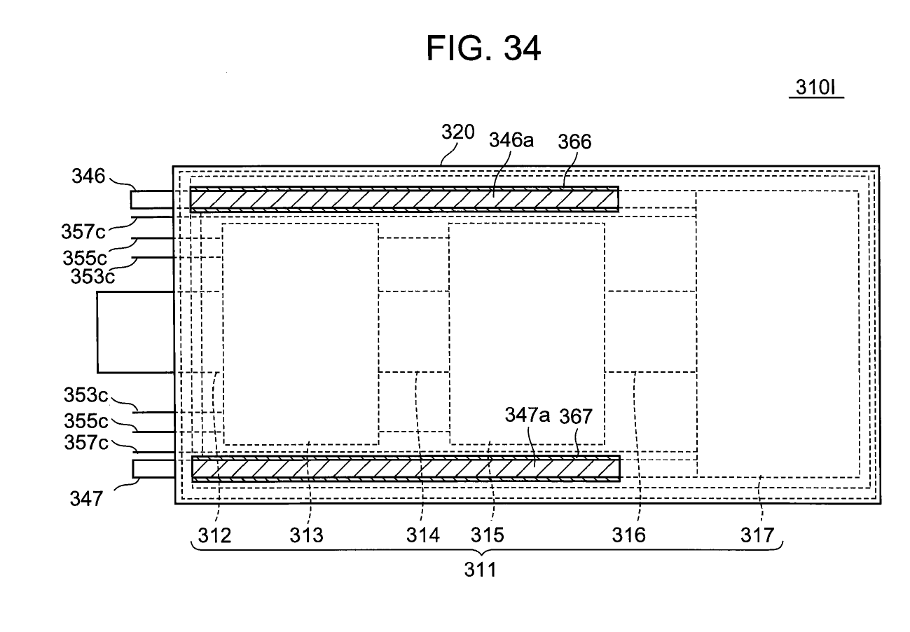

The radiation discharging films 346a, 347a and the radiation transmitting windows 366, 367 are provided at relatively low temperature portions (50-645° C.) in the anode output electrode 346 and the cathode output electrode 347 to discharge the radiation. FIG. 34 is a bottom diagram of a reaction device 310I according to a third example of the present invention. A schematic cross-section diagram of the reaction device 310I is omitted because it is same as FIG. 32.

### FOURTH EXAMPLE

The radiation discharging films 346a, 347a and the radiation transmitting windows 366, 367 are provided at middle temperature portions (300-655° C.) in the anode output electrode 346 and the cathode output electrode 347 to discharge the radiation.

### FIFTH EXAMPLE

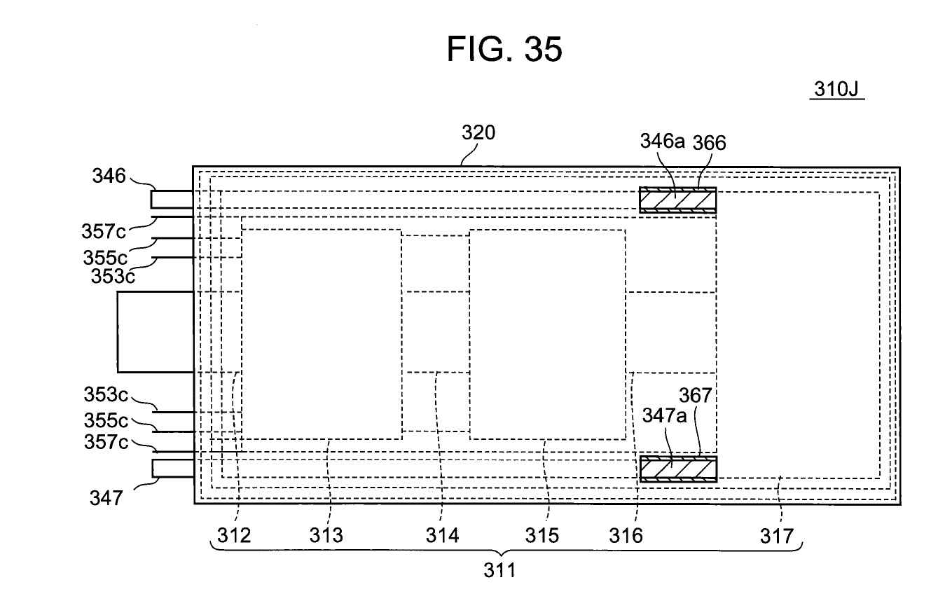

The radiation discharging films 346a, 347a and the radiation transmitting windows 366, 367 are provided at relatively high temperature portions (707-800° C.) in the anode output electrode 346 and the cathode output electrode 347 to discharge the radiation. FIG. 35 is a bottom diagram of a reaction device 310J according to a fifth example of the present invention. A schematic cross-section diagram of the reaction device 310J is omitted because it is same as FIG. 32.

### THIRD COMPARISON EXAMPLE

The radiation discharging film 317a and the radiation transmitting window 367 are provided in the high temperature reaction section 317 to discharge the radiation. In this case, the calculation is performed on the assumption that the radiation of Qₛᵣ=4.5 W is discharged in the high temperature reaction section.

### FOURTH COMPARISON EXAMPLE

The radiation discharging is not performed. In this case, the calculation is performed on the assumption that Qₛ₁=5 W.

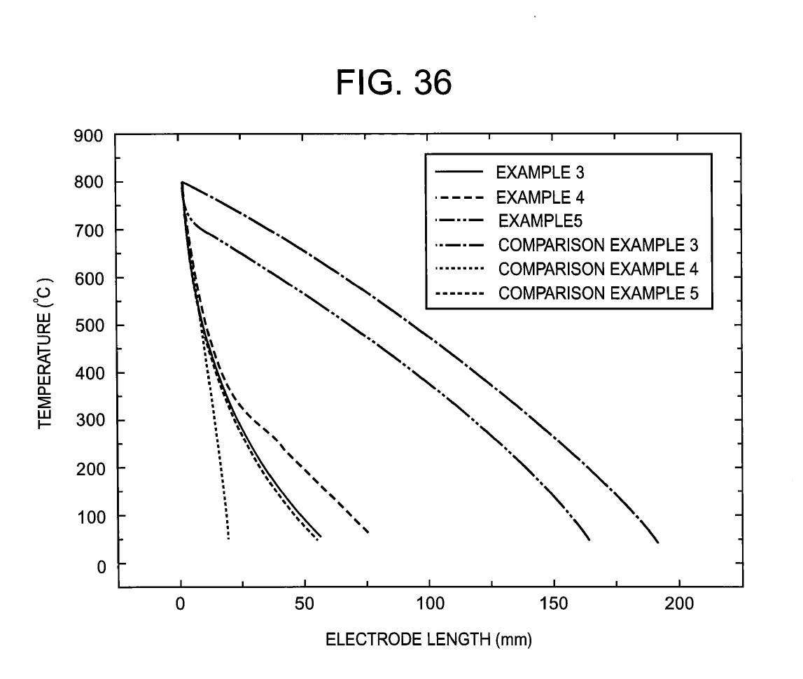

FIG. 36 is a graph showing a result of calculating relations between lengths of the anode output electrodes 346 and the cathode output electrodes 347 from the high temperature reaction section 317 and the temperature in the above-described third-fifth examples and the third and fourth comparison examples. The same results are shown in table 2.

TABLE 2

| | | | Comparison | Comparison |
|---|---|---|---|---|
| Example 3 | Example 4 | Example 5 | example 3 | example 4 |
| 56.1 mm | 76.8 mm | 165.9 mm | 191.2 mm | 19.15 mm |

In the above-described third example, by discharging the heat radiation in regions (whose length is 51 mm from the end (second end) connected to the heat insulating container 320) of the anode output electrode 346 and the cathode output electrode 347, the region has the temperature of 50-645° C., each of the above-described conditions of the temperature and the heat quantity are satisfied.

In the above-described fourth example, by discharging the heat radiation in regions (23.65 mm between an end connected to the heat insulating container 320 and an end (first end) of the anode output electrode 346 and the cathode output electrode 347, the region has the temperature of 300-655° C., each of the above-described conditions of the temperature and the heat quantity are satisfied.

In the above-described fifth example, by discharging the heat radiation in regions (whose length is 5.9 mm from an end connected to the high temperature reaction section 317) of the anode output electrode 346 and the cathode output electrode 347, the region has the temperature of 707-800° C., each of the above-described conditions of the temperature and the heat quantity are satisfied.

In the above-described third comparison example, since the heat transmission quantity over the entire lengths of the anode output electrode 346 and the cathode output electrode 347 is 0.5 W, Δx becomes 191.2 mm according to the formula (1).

In the above-described fourth comparison example, since the heat transmission quantity over the entire lengths of the anode output electrode 346 and the cathode output electrode 347 is 5 W, Δx becomes 19.15 mm according to the formula (1).

The above-described results will be explained below. According to the formula (1), when the heat is conducted in a certain object, a heat difference per unit length of the object is proportional to the heat transmission quantity.

As the fourth comparison example, when the radiation is not discharged, the length of each of the electrodes can be shortened because the heat transmission quantity in the electrodes is large, 5 w, but it is necessary to discharge the radiation in other regions. Moreover, when the heat quantity of 4.5 W is discharged by the radiation in the high temperature reaction section 317 as the third comparison example, the length of each of the electrodes becomes long because the heat transmission quantity in the electrodes is small, 0.5 W.

When 4.5 W is discharged by the radiation from electrode portions as the third to fifth examples, the heat transmission quantity in the end which is connected to the high temperature reaction section 317 and has the temperature of 800° C. is 5 W, and the heat transmission quantity in the end which is connected to the heat insulating container 320 and has the temperature of 50° C. is 0.5 W.

In the third comparison example, the radiation is discharged in contiguous relatively low temperature regions of the anode output electrode 346 and the cathode output electrode 347, which regions include the second end connected to the heat insulating container 320. In this case, the heat quantity of 4.5 W can be discharged in the region whose length is 51 mm from the second end, and the temperature of each of the electrode in the portion at 51 mm from the second end becomes 645° C. In addition, since the heat transmission quantity of the portion nearer to the second end connected to the high temperature reaction section 317 than the above portion is 5 W, and since the temperature is lowered from 800° C. to 645° C. at this heat transmission quantity, the length of Δx=5.1 mm becomes necessary according to the formula (1).

In the fifth comparison example, the radiation discharging is performed in contiguous relatively high temperature regions of the anode output electrode 346 and the cathode output electrode 347, which regions include the first end connected to the high temperature reaction section 317. In this case, the heat quantity of 4.5 W can be discharged in the region whose length is 5.9 mm from the first end, and the temperature of each of the electrode in the portion at 5.9 mm from the first end becomes 707° C. In addition, since the heat transmission quantity of the portion nearer to the second end connected to the heat insulating container 320 than the above portion is 0.5 W, and since the temperature is lowered from 707° C. to 50° C. at this heat transmission quantity, the length of Δx=160 mm becomes necessary according to the formula (1).

In the fourth comparison example, the radiation discharging is performed in contiguous regions of the anode output electrode 346 and the cathode output electrode 347, which regions are in middle temperature region within the range of 300-655° C. Therefore, the radiation is not discharged at the first end of 800° C. or the second end of 50° C. In this case, the radiation of 4.5 W has been discharged at the position of 23.65 mm from the position of 655° C., and the temperature of each of the electrodes becomes 300° C. at the same time. The heat transmission quantity in the contiguous regions of each of the electrodes including the first end, which regions have the temperature of higher than 655° C., is 5 W, and the temperature is lowered from 800° C. to 655° C. at this heat transmission quantity. Therefore, the length of Δx₁=4.75 mm becomes necessary according to the formula (1). Moreover, the heat transmission in the contiguous regions of each of the electrodes including the second end, which regions have the temperature of lower than 300° C., is 0.5 W, and the temperature is lowered from 655° C. to 50° C. at this heat transmission quantity. Therefore, the length of Δx₂=48.4 mm becomes necessary according to the formula (1). Thus, a total length becomes a sum of Δx₁, Δx₂, and the length of the region discharging the radiation, namely 76.0 mm.

As described above, the anode output electrode 346 and the cathode output electrode 347 can be shorter in the case where the radiation is discharged in the anode output electrode 346 and the cathode output electrode 347 than the case where the same heat quantity is discharged by the radiation only in the high temperature reaction section 317. Thus, the reaction device 310H can be downsized.

Moreover, similar to the fifth embodiment, when the predetermined energy amount, for example 3 W is discharged by the radiation, the areas of the radiation transmitting windows 366, 377 can be smaller in the case where the radiation discharging films 346a, 347a and the radiation transmitting windows 366, 367 are provided in the relatively high temperature region of the anode output electrode 346 and the cathode output electrode 347 to discharge the radiation as the fifth example, than the case where the radiation is discharged from the relatively low temperature region as the third example. Thus, the reaction device 310H can be downsized more easily. In addition, it becomes easier to obtain the material of the radiation discharging windows 366, 367 having high radiation transmittance ratio to allow the radiation of the wavelength corresponding to the temperature range to transmits though efficiently.

On the other hand, when the radiation discharging films 346a, 347a and the radiation transmitting windows 366, 367 are provided in the relatively low temperature regions of the anode output electrode 346 and the cathode output electrode 347 to discharge the radiation, the total lengths of the anode output electrode 346 and the cathode output electrode 347 can be shorter. Moreover, as described above, when the predetermined energy amount, for example 3 W is discharged by the radiation, the area for discharging by the radiation becomes large, and the radiation is not concentrated and dispersed. As a result, when the reaction device is mounted in the electronic equipment, safety of the electronic equipment for a user can be improved.

When the radiation is discharged from the anode output electrode 346 and the cathode output electrode 347 as the embodiments, the following advantages can be further obtained.

Firstly, since a part of the heat quantity conducted from the high temperature reaction section 317 to the anode output electrode 346 and the cathode output electrode 347 is radiated from the radiation discharging films 346a, 347a to be discharged from the radiation transmitting windows 366, 367 to outside of the heat insulating container 320, the temperatures of the high temperature reaction section 317 and the heat insulating container 320 can be maintained appropriately while suppressing the heat transmission quantity from the high temperature reaction section 317 to the heat insulating container 320 through the anode output electrode 346 and the cathode output electrode 347.

Moreover, when the radiation is discharged from the high temperature reaction section 317, the middle temperature reaction section 315 and the low temperature reaction section 313 which perform reactions, since the temperatures inside the reaction sections need to be uniform, the radiation discharging film and the radiation transmitting window need to be located in view of temperature distribution in each of the reaction sections. On the other hand, in the sixth embodiment, since the anode output electrode 346 and the cathode output electrode 347 are not required to have inner uniform temperature unlike the above-described reaction sections, any regions in the electrodes may be the radiation discharging regions. Therefore, a design restriction for forming the radiation discharging films 346a, 347a and the radiation transmitting windows 366, 367 can be reduced. Especially, since a design of portable type electronic equipment is restricted not to discharge the radiation to a user, the embodiment is preferable as being capable of reduce the design restriction.

Furthermore, according to the formula (1), if the anode output electrode 346 and the cathode output electrode 347 are thinned or lengthened in order to allow the heat transmission quantity to the heat insulating container 320 to be small, an electric resistance of each of the electrodes increases so that a power generation efficiency falls. However, by discharging the radiation from each of the electrodes, the heat transmission quantity to the heat insulating container 320 can be small, while keeping the electric resistance low and the power generation efficiency high, without changing the shapes of the electrodes.

Incidentally, though the radiation discharging films 346a, 347a are provided on the lower surface of the electrode and the radiation discharging windows 366, 367 are provided on the lower surface of each of the reaction devices 310H, 310I, 310J in the above-described sixth embodiment, the configurations are not limited to the above, and the radiation discharging films 346a, 347a and the radiation discharging windows 366, 367 may be provided on other surfaces.

### Seventh Embodiment

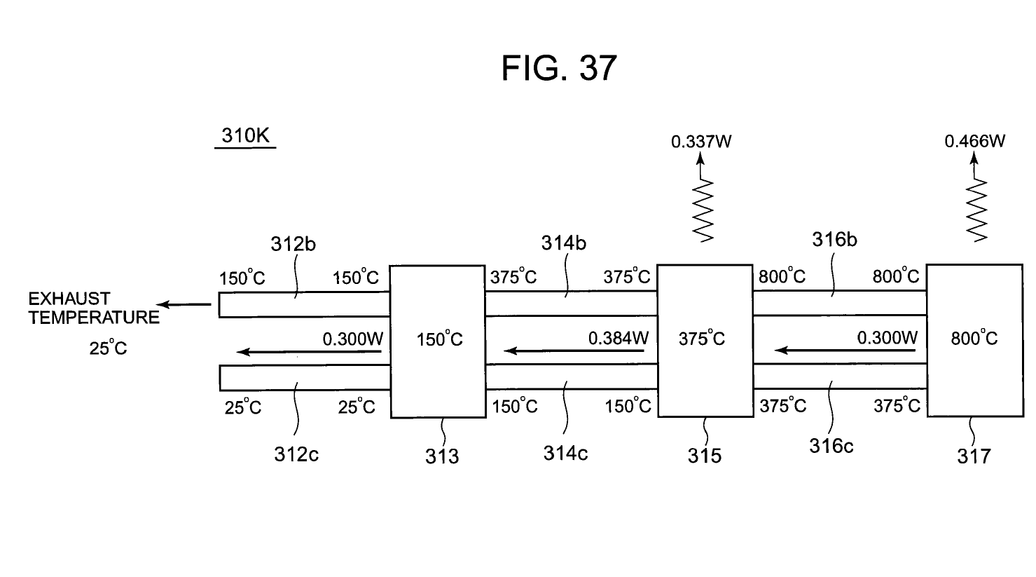

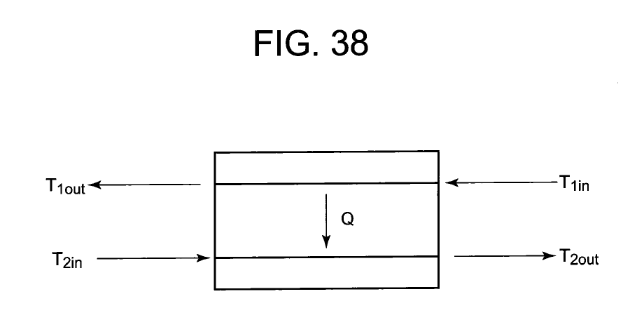

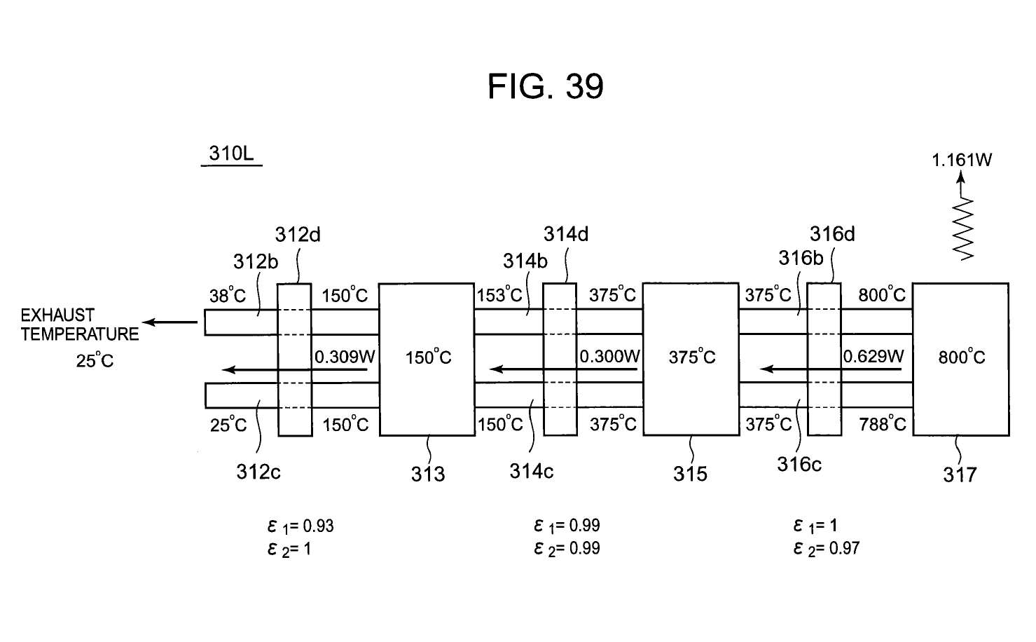

FIG. 37 is a schematic diagram showing the temperature and the heat quantity of a reaction device 310K according to a fifth comparative example in a steady state, FIG. 38 is a schematic diagram for explaining the ideal heat exchange, and FIG. 39 is a schematic diagram showing the temperature and the heat quantity of a reaction device 310L according to a seventh embodiment in a steady state.

Each of the reaction devices 310K, 310L includes: an inflow pipe 312b and an outflow pipe 312c as the first connecting section 312; the low temperature reaction section 313; an inflow pipe 314b and an outflow pipe 314c as the second connecting section 314; the middle reaction section 315; an inflow pipe 316b and an outflow pipe 316c as the third connecting section 316; and the high temperature reaction section 317. The reaction device 310L further includes: a heat exchanger 312d to perform heat exchange between the inflow pipe 312b and the outflow pipe 312c; a heat exchanger 314d to perform the exchange between the inflow pipe 314b and the outflow pipe 314c; and a heat exchanger 316d to perform heat exchange between the inflow pipe 316b and the outflow pipe 316c.

The inflow pipe and the outflow pipe are integrally provided or adjoined to each other to perform the heat exchange between the pipes. Each of the pipes may include a plurality of pipes. For example, by dividing the outflow pipe into two outflow pipes to place each of the outflow pipes around the inflow pipe, the heat exchange between the outflow pipe and the inflow pipe becomes likely to be performed. Incidentally, the outflow pipes in the embodiment correspond to the first pipe, the third pipe and the fifth pipe respectively, and the inflow pipes in the embodiment correspond to the second pipe, the fourth pipe and the sixth pipe respectively.

The inflow pipe 312b of the first connecting section 312 is a pipe through which the reactant to react in the low temperature reaction section 313 flows, and the reactant is supplied to the low temperature reaction section 313 through the inflow pipe 312b. The outflow pipe 312c of the first connecting section 312 is a pipe through which the product produced in the low temperature reaction section 313 flows, and the product is discharged from the low temperature reaction section 313 through the outflow pipe 312c. The inflow pipe 314b of the second connecting section 314 is a pipe through which the reactant to react in the middle temperature reaction section 315, and the reactant is supplied to the middle temperature reaction section 315 through the inflow pipe 314b. The outflow pipe 314c of the second connecting section 314 is a pipe through which the product produced in the middle temperature reaction section 315, and the product is discharged from the middle temperature reaction section 315 through the outflow pipe 314c. The inflow pipe 316b of the third connecting section 316 is a pipe through which the reactant to react in the high temperature reaction section 317, and the reactant is supplied to the high temperature reaction section 317 through the inflow pipe 316b. The outflow pipe 316c of the third connecting section 316 is a pipe through which the product produced in the high temperature reaction section 317, and the product is discharged from the high temperature reaction section 317 through the outflow pipe 316c.

This comparison example shown in FIG. 37 will be explained. In this comparison example, the heat exchange is not performed between each of the outflow pipes 312b, 314b, 316b and each of the inflow pipes 312c, 314c, 316c. The middle temperature reaction section 315 includes a not-shown radiation discharging film 315a, and is placed opposite a not-shown radiation transmitting window 325 in the inner wall of the heat insulating container 320. The high temperature reaction section 317 includes a not-shown radiation discharging film 317a, and is placed opposite a not-shown radiation transmitting window 327 on the inner wall of the heat insulating container 320.

The following calculated values are calculated on the assumption that an actual output of the fuel cell device is 1.4 W, the electricity generated is 1.7 W, and 0.3 W is consumed inside the fuel cell device.

Since the temperature of the reactant supplied to the high temperature reaction section 317 through the inflow pipe 316a is 375° C. and the reaction temperature of the high temperature reaction section 317 is 800° C., a part of the heat quantity of the exothermic reaction occurring in the high temperature reaction section 317 is used as sensible heat for rising the temperature of the reactant, and surplus heat of 0.766 W is generated in the high temperature reaction section 317. The heat quantity to be conducted to the middle temperature reaction section 315 through the third connecting section 316 among the surplus heat is 0.300 W, and the heat quantity to be discharged by the radiation from the radiation discharging film 317a of the high temperature reaction section 317 through the radiation transmitting window 327 is 0.466 W.

Moreover, by discharging by the heat quantity of 0.337 W from the radiation discharging film 315a of the middle temperature reaction section 315 through the radiation transmitting window 325, the temperature of the middle temperature reaction section 315 can be maintained at 375° C. and the temperature of the low temperature reaction section 313 can be maintained at 150° C. while suppressing the heat transmission quantity of the reaction device to the external apparatus at 0.300 W. Thus, in this comparison example, by providing the radiation transmitting windows 325, 327 respectively in the middle temperature reaction section 315 and the high temperature reaction section 317, the temperatures of the reaction sections are maintained appropriately while suppressing the heat transmission quantity to the heat insulating container.

An ideal heat exchange will be explained. T₁ᵢₙ and T₁ₒᵤₜ in FIG. 38 correspond to the outflow pipes in FIGS. 37 and 39, and T₂ᵢₙ and T₂ₒᵤₜ correspond to the inflow pipes in FIGS. 37 and 39. When the ideal heat exchange is performed with the heat quantity Q moves from the outflow pipe to the inflow pipe, the temperature efficiency ε satisfies the following formulas (29), (30).

### [Formula 12]

ε₁=(T₁ᵢₙ−T₁ₒᵤₜ)/(T₁ᵢₙ−T₂ᵢₙ) (29)

ε₂=(T₂ₒᵤₜ−T₂ᵢₙ)/(T₁ᵢₙ−T₂ᵢₙ) (30)

The embodiment shown in FIG. 39 will be explained. In the embodiment, the heat exchange is performed between each of the outflow pipes 312b, 314b, 316b and each of the inflow pipes 312c, 314c 316c. The high temperature reaction section 317 includes a not-shown radiation discharging film 317a, and is placed opposite a not-shown radiation transmitting window 327 on the inner wall of the heat insulating container 320. The radiation discharging is not performed in the middle temperature reaction section 315.

Similar to this comparison example, also the following calculated values are calculated on the assumption that an actual output of the fuel cell device is 1.4 W, the electricity generated is 1.7 W, and 0.3 W is consumed inside the fuel cell device.

In the embodiment, by performing the heat exchange between the inflow pipe 316c and the outflow pipe 316b, the temperature of the product in the high temperature reaction section 317 is lowered from 800° C. to 375° C. while flowing through the outflow pipe 316b, and the heat quantity corresponding to a sensible heat of the temperature fall is used as a sensible heat for rising the temperature of the reactant (product discharged from the middle temperature reaction section 315) flowing inside the inflow pipe 316c. In this case, the reason why ε₁=1 and ε₂=0.97 is that the calculation is performed based on the fuel amount for achieving the output value, and it can be considered that the ideal heat exchange is performed substantially.

For this reason, since the temperature of the reactant supplied to the high temperature reaction section 317 through the inflow pipe 316c is 788° C. and the reaction temperature of the high temperature reaction section 317 is 800° C., the heat quantity used as the sensible heat for rising the temperature of the reactant among the heat quantity of the exothermic reaction occurring in the high temperature reaction section 317 is drastically reduced in comparison with this comparison example. Therefore, in high temperature reaction section 317, the surplus heat of 1.790 W which is larger than that of this comparison example occurs. The heat quantity to be conducted to the middle temperature reaction section 315 through the third connecting section 316 among the surplus heat is 0.629 W, and the heat quantity to be discharged by the radiation from the radiation discharging film 317a of the high temperature reaction section 317 through the radiation transmitting window 327 is 1.161 W.

Moreover, since the heat exchange is performed between the inflow pipe 314c and the outflow pipe 314b, a part of the surplus heat in the middle temperature reaction section 315 is used as the sensible heat for rising the temperature of the reactant (product discharged from the low temperature reaction section 313) flowing inside the inflow pipe 314c. On the other hand, since the heat quantity of 0.300 W which is a residual of the surplus heat of the middle temperature reaction section 315 is conducted from the middle temperature reaction section 315 to the low temperature reaction section 313 through the second connecting section 314, the radiation needs not to be discharged in the middle temperature reaction section 315. Also in this case, though ε₁=0.99 and ε₂=0.99 since the calculation is performed based on the fuel amount for achieving the output value, it can be considered that the ideal heat exchange is performed substantially.

Furthermore, by performing the heat exchange between the inflow pipe 312c and the outflow pipe 312b, a part of the surplus heat of the low temperature reaction section 313 is used as a sensible heat for rising the temperature of the reactant (reactant supplied from outside of the reaction device) flowing inside of the inflow pipe 312c. On the other hand, since the heat quantity of 0.309 W which is a residual of the surplus heat of the low temperature reaction section 313 is conducted from the low temperature reaction section 313 to outside of the reaction device through the first connecting section 312, the radiation needs not to be discharged in the low temperature reaction section 313. Also in this case, though ε₁=0.93 and ε₂=1 since the calculation is performed based on the fuel amount for achieving the output value, it can be considered that the ideal heat exchange is performed substantially.

Incidentally, with respect to the embodiment and the comparison examples, the heat quantity absorbed by the chassis and the like of the electrical equipment on which the fuel cell device is mounted will be explained.

In this comparison example, the temperature of the off gas ejected from the first connecting section 312 is 150° C., and the heat quantity of 0.466 W corresponding to the sensible heat for lowering the temperature of the off gas to 25° C. as an exhaust temperature is absorbed by the chassis of the electronic equipment. Moreover, since the heat quantity of 0.703 W corresponding to latent heat at the time when the off gas is condensed, the heat quantity of 0.300 W by conduction from the low temperature reaction section 313 through the first connecting section 312, the heat quantity of 0.104 W to be absorbed in the radiation transmitting window, and the heat quantity of 0.300 W corresponding to the electric power to be consumed inside the fuel cell device are absorbed in the chassis of the electronic equipment respectively, the sum of the heat quantities becomes 1.873 W.

On the other hand, in the embodiment, since the temperature of the off gas ejected from the first connecting section 312 is 38° C., and since the heat quantity of 0.025 W corresponding to the sensible heat for lowering the temperature of the off gas to 25° C. as an exhaust temperature, the heat quantity of 0.089 W corresponding to latent heat at the time when the off gas is condensed, the heat quantity of 0.309 W by conduction from the low temperature section 313 through the first connecting section 312, the heat quantity of 0.111 to be absorbed in the radiation transmitting window, and the heat quantity of 0.300 W corresponding to the electric power to be consumed inside the fuel cell device are absorbed in the chassis of the electronic equipment respectively, the sum of the heat quantities becomes 1.094 W.

As describe above, in the embodiment, since the heat quantity to be absorbed in the chassis of the electronic equipment can be reduced by 0.779 W in comparison with this comparison example, the temperature of the chassis of the electronic equipment can be prevented from rising. Moreover, as described later, when the fuel cell device of the present invention is mounted on the electronic equipment, it is preferable that the radiation is discharged from the outermost surface of the electronic equipment in order to prevent reabsorption of the radiation by the chassis of the electronic equipment and the like. Therefore, when mounting on the electronic equipment, a design restriction can be reduced more in the embodiment where the radiation transmitting window is provided at only one place than this comparison example where the radiation transmitting windows are provided at two places. Especially, since a design of portable type electronic equipment is restricted not to discharge the radiation to a user, the embodiment is preferable as being capable of reduce the design restriction.

Moreover, according to the formula (4), the radiation energy amount per unit area of the radiation transmitting window increases in proportion to the fourth power of the temperature. Therefore, when the same energy amounts are discharged by the radiation, the area of the radiation transmitting window can be smaller and the radiation energy amount can be larger in the case where the radiation discharging film is provided at the relatively high temperature region of the reaction device body to discharge the radiation through the radiation transmitting window, then the case where the radiation is discharged from the relatively low temperature region. When the fuel cell device is mounted on the electronic equipment, a design restriction can be reduced much more when the area of the radiation transmitting window is smaller.

Incidentally, only one of the radiation discharging films 346a, 347a may be provided, and only one of the radiation transmitting windows 366, 367 facing the one radiation discharging film may be provided.

Furthermore, any two or more of the radiation discharging films 312a, 313a, 314a, 315a, 316a, 317a, 346a, 347a may be provided. In this case, two or more of radiation transmitting windows 322, 323, 324, 325, 326, 327, 366, 367 need to be provided.

Although various typical embodiments have been shown and described, the present invention is not limited to those embodiments. Consequently, the scope of the present invention can be limited only by the following claims.

What is claimed is:

1. A reaction device comprising:
a reaction device body including a reaction section in which a reactant reacts; and
a first container to house the reaction device body,
wherein the first container includes a radiation transmitting region through which radiation from the reaction device body transmits.

2. The reaction device according to claim 1,
wherein at least one of CaF₂, BaF₂, ZnSe, MgF₂, KRS-5, KRS-6, LiF, SiO₂, CsI, KBr, AlF₃, NaCl, KF, KCl, CsCl, CsBr, CsF, NaBr, CaCO₃, KI, NaI, NaNO₃, AgCl, AgBr, TlBr, Al₂O₃, BiF₃, CdSe, CdS, CdTe, CeF₃, CeO₂, Cr₂O₃, DyF₂, Fe₂O₃, GaAs, GaSe, Gd₂O₃, Ge, HfO₂, HoF₃, Ho₂O₃, La₂O₃, MgO, NaF, Nb₂O₅, PbF₂, Si, Si₃N₄, SrF₂, TlCl, YF₃, Y₂O₃, ZnO, ZnS, and ZrO₂ is used in the radiation transmitting region of the first container, and
transmittance in a infrared region of the material used in a portion of the first container except the radiation transmitting region is lower than that of the material used in the radiation transmitting region of the first container.

3. The reaction device according to claim 1,
wherein at least one of CaF₂, BaF₂, ZnSe, MgF₂, KRS-5, KRS-6, LiF, SiO₂, CsI, KBr, AlF₃, NaCl, KF, KCl, CsCl, CsBr, CsF, NaBr, CaCO₃, KI, NaI, NaNO₃, AgCl, AgBr, TlBr, Al₂O₃, BiF₃, CdSe, CdS, CdTe, CeF₃, CeO₂, Cr₂O₃, DyF₂, Fe₂O₃, GaAs, GaSe, Gd₂O₃, Ge, HfO₂, HoF₃, Ho₂O₃, La₂O₃, MgO, NaF, Nb₂O₅, PbF₂, Si, Si₃N₄, SrF₂, TlCl, YF₃, Y₂O₃, ZnO, ZnS, and ZrO₂ is used in the whole first container.

4. The reaction device according to claim 1,
wherein at least one of Au, Al, Ag, Cu and Rh is used in an inner wall surface of the portion of the first container except the radiation transmitting region.

5. The reaction device according to claim 1,
wherein on a facing surface of the reaction device body facing the radiation transmitting region, a radiation discharging region having a higher emissivity in a infrared region than that of an outer wall surface of the reaction device body in a portion except the facing surface of the reaction device body facing the radiation transmitting region is provided.

6. The reaction device according to claim 1,
wherein a radiation preventing film for preventing a radiation from the reaction device body is provided on an outer wall surface of the reaction device body in a portion except at least the facing surface of the reaction device body facing the radiation transmitting region.

7. The reaction device according to claim 5,
wherein the radiation discharging region is formed by a non-evaporation type getter.

8. The reaction device according to claim 1,
wherein a pressure outside the reaction device body and inside the first container is lower than an atmospheric pressure.

9. The reaction device according to claim 1,
wherein the reaction section is placed opposite the radiation transmitting region.

10. The reaction device according to claim 1,
wherein the reaction device body includes two or more reaction sections in each of which the reactant reacts and temperatures of the two or more reaction sections are different from each other, and
at least one of the two or more reaction sections is placed opposite the radiation transmitting region.

11. The reaction device according to claim 1,
wherein the reaction section includes a vaporizer to vaporize fuel and water to produce mixed gas, and
at least one of KRS-5, KRS-6, CsI, KBr, NaCl, KCl, CsCl, CsBr, NaBr, KI, NaI, AgCl, AgBr, TlBr, CdSe, CdTe and Ge is used in the radiation transmitting region.

12. The reaction device according to claim 1,
wherein the reaction section includes a reformer to produce reformed gas from the vaporized fuel and water, and
at least one of ZnSe, KRS-5, KRS-6, CsI, KBr, NaCl, KCl, CsCl, CsBr, CsF, NaBr, KI, NaI, AgCl, AgBr, TlBr, BiF₃, CdSe, CdS, CdTe, GaAs, GaSe, Ge, NaF, PbF₂, TlCl, YF₃ and ZnO is used in the radiation transmitting region.

13. The reaction device according to claim 1,
wherein the reaction section includes a fuel cell to produce an electric power by reaction of the reactant.

14. The reaction device according to claim 13,
wherein the fuel cell is a molten carbonate fuel cell, and
at least one of CaF₂, BaF₂, ZnSe, KRS-5, KRS-6, CsI, KBr, AlF₃, NaCl, KF, KCl, CsCl, CsBr, CsF, NaBr, KI, NaI, AgCl, AgBr, TlBr, BiF₃, CdSe, CdS, CdTe, CeF₃, CeO₂, DyF₂, GaAs, GaSe, Gd₂O₃, Ge, HfO₂, La₂O₃, NaF, PbF₂, Si, TlCl, YF₃, ZnO and ZnS is used in the radiation transmitting region.

15. The reaction device according to claim 13,
wherein the fuel cell is a solid oxide fuel cell, and
at least one of CaF₂, BaF₂, ZnSe, MgF₂, KRS-5, KRS-6, CsI, KBr, AlF₃, NaCl, KF, KCl, CsCl, CsBr, CsF, NaBr, KI, NaI, AgCl, AgBr, TlBr, BiF₃, CdSe, CdS, CdTe, CeF₃, CeO₂, DyF₂, GaAs, GaSe, Gd₂O₃, HfO₂, La₂O₃, MgO, NaF, PbF₂, Si, Si₃N₄, SrF₂, TlCl, YF₃, Y₂O₃, ZnO and ZnS is used in the radiation transmitting region.

16. Electronic equipment comprising:
the reaction device according to claim 13; and
an electronic equipment body to operate by the electric power of the fuel cell.

17. The electronic equipment according to claim 16,
wherein the radiation transmitting region is located along an outer circumference surface of the electronic equipment.

18. The reaction device according to claim 1,
wherein the reaction device body includes a connecting section through which the reactant to react in the reaction section or a product produced in the reaction section flows, and
the connecting section is placed opposite the radiation transmitting region.

19. The reaction device according to claim 18,
wherein a high temperature side of the connecting section is placed opposite the radiation transmitting region.

20. The reaction device according to claim 18,
wherein a low temperature side of the connecting section is placed opposite the radiation transmitting region.

21. The reaction device according to claim 18,
wherein the reaction device body includes a second reaction section having lower temperature than the reaction section,
the connecting section includes a first connecting section a first end of which is connected to the second reaction section and a second end of which penetrates the first container, and a second connecting section connecting the reaction section and the second reaction section, and
at least one of the first connecting section and the second connecting section is placed opposite the radiation transmitting region.

22. The reaction device according to claim 18,
wherein the reaction device body includes an inflow pipe for sending the reactant to the reaction section and an outflow pipe for sending the product produced in the reaction section, and
heat exchange is performed between the inflow pipe and the outflow pipe.

23. The reaction device according to claim 18,
wherein the reaction section includes a fuel cell to produce an electric power by reaction of the reactant.

24. Electronic equipment comprising:
the reaction device according to claim 23; and
an electronic equipment body to operate by the electric power of the fuel cell.

25. A reaction device comprising:
a reaction device body includes a fuel cell to produce an electric power by reaction of the reactant, and an output electrode for sending the electric power of the fuel cell; and
a first container to house the reaction device body,
wherein the first container includes a radiation transmitting region through which radiation from the reaction device body transmits, and the output electrode is placed opposite the radiation transmitting region in the first container.

26. A reaction device according to claim 25,
wherein a high temperature side of the output electrode is placed opposite the radiation transmitting region.

27. A reaction device according to claim 25,
wherein a low temperature side of the output electrode is placed opposite the radiation transmitting region.

28. Electronic equipment comprising:
the reaction device according to claim 25; and
an electronic equipment body to operate by the electric power of the fuel cell.
